(19) United States
(12) Patent Application Publication
(10) Pub. No.: US 2003/0004064 A1
(43) Pub. Date: Jan. 2, 2003

(54) Synergistic active compound combinations for controlling harmful plants

(76) Inventors: Hartmut Ahrens, Frankfurt (DE); Klemens Minn, Hattersheim (DE); Hansjorg Dietrich, Hofheim (DE); Lothar Willms, Hofheim (DE); Erwin Hacker, Hochheim (DE); Hermann Bieringer, Eppstein (DE)

Correspondence Address: FROMMER LAWRENCE & HAUG LLP, 745 Fifth Avenue, New York, NY, 10151, US

(21) Appl. No.: 10/116,352

(22) Filed: Apr. 4, 2002

(30) Foreign Application Priority Data
Apr. 7, 2001 (DE) 101 17 508.6

(51) Int. Cl. A01N 43/64

(52) U.S. Cl. 504/133; 504/134

(57) ABSTRACT

The invention relates to synergistic herbicide combinations for controlling harmful plants in crops of plants. The combinations comprise active compounds (A) and (B), where (A) are optically active aminotriazines having a partial structure of the formula (I), or salts thereof,

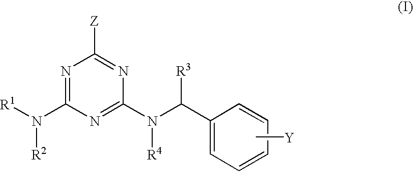

where

Z and R¹ to R⁴ and Y are as defined in claim 1 and the compounds of the formula (I) are optically active and not present as racemic compounds,

and

(B) is one or more herbicides selected from the group of compounds consisting of

(B1) foliar- and/or soil-acting herbicides which are active against monocotyledonous harmful plants,

(B2) herbicides which are active against predominantly dicotyledonous harmful plants, and

(B3) herbicides which are active against monocotyledonous and dicotyledonous harmful plants and, if appropriate

(B4) herbicides which are active against monocotyledonous and dicotyledonous harmful plants and which can be employed specifically in tolerant crops or on non-crop land.

The invention relates to the technical field of crop protection agents, in particular to combinations of groups of active compounds having different modes of action and types of activity, which are outstandingly suitable for use against harmful plants in crops of useful plants.

In many crops of useful plants, harmful plants are undesirable competitors which can be controlled only with considerable expense and at high cost. They germinate and grow in the soil over prolonged periods of time and can therefore only be effectively controlled with herbicides having foliar and soil action. Examples of economically important harmful plants which occur in crops of useful plants all over the world are the following harmful plants:

Alcopecurus myosuroides, Avena fatua and other forms of wild oat, Lolium spp., Phalaris spp., Setaria spp., Echinochloa spp., Poa spp., Bromus spp., Elymus repens, Sorghum spp. and others, such as Agrostis spp. and Panicum spp. Herbicides suitable for controlling such harmful plants are, for example, those of the group of some derivatives of 2,4-diamino-1,3,5-triazine substituted in the 6-position (short amino triazines), as described in WO-A 97/08156, WO-A-97/31904, DE-A-19826670, WO-A-98/15536, WO-A-98/15537, WO-A-98/15538, WO-A-98/15539 and also DE-A-19828519, WO-A-98/34925, WO-A-98/42684, WO-A-99/18100, WO-A-99/19309, WO-A-99/37627, WO-A-99/44999, WO-A-99/46249, WO-A-99/65882 and WO-A-00/00480, WO-A-00/32580, WO-A-00/47579, WO-A-00/56722, WO-A-00169854 and WO-A-01/10849.

The effectiveness of these herbicides against harmful plants in the plant crops is at a high level; however, it depends in general on the application rate, the respective formulation, the harmful plants to be controlled in each case or the spectrum of harmful plants, the climatic and soil conditions, etc. A further criterion is the duration of action, or the rate of degradation of the herbicide. Also to be taken into account are, if appropriate, changes in the sensitivity of harmful plants which may occur on prolonged use of the herbicides or geographically restricted. Activity losses in individual plants can only be compensated to a certain extent by higher application rates of the herbicides, for example because this frequently decreases the selectivity of the herbicides, or an improvement in activity is not observed, even at higher application rates. In some cases, it is possible to improve the selectivity in crops by addition of safeners. In general, however, there is always a need for methods to achieve the herbicidal action with a lower application rate of active compounds. A lower application rate reduces not only the amount of an active compound which is required for the application, but generally also reduces the amount of formulation auxiliaries required. Both reduce the economic expense and improve the ecological compatibility of the herbicide treatment.

One possibility for improving the property profile of a herbicide may consist in the combination of the active compound with one or more other active compounds which contribute the desired additional properties. However, when two or more active compounds are applied in combination, it is not uncommon for phenomena of physical and biological incompatibility to occur, for example lack of stability in a coformulation, decomposition of an active compound or antagonism of the active compounds. In contrast, what is desired are combinations of active compounds having a favorable activity profile, high stability and, if possible, synergistically enhanced activity, which permits a reduction of the application rate, compared with the individual application of the active compounds to be combined.

In the publications cited above, it has already been proposed to combine the active compounds described with known herbicides, and an extensive list of possible combination partners has been given. However, indications of favorable, in particular synergistic, properties of specific combinations have not been given.

Some herbicide combinations comprising, as one component, herbicides from the group of the 2,4-diamino-1,3,5-triazines have already been disclosed, with synergistic effects, inter alia, also being described; cf. WO-A-98110654, JP-A-10025211, WO-A-97/35481, JP-A-08198712, EP-A-573897, EP-A-573898 and WO-A-0016627.

Surprisingly, it has now been found that certain active compounds from the group of the aminotriazine herbicides mentioned interact in a particularly favorable manner in combination with certain structurally different herbicides when used in crops of plants which are suitable for the selective use of the herbicides.

The invention provides herbicide combinations which differ from the prior art or have technical advantages, and which have a synergistically active content of components (A) and (B), where component (A) is one or more herbicidally active optically active aminotriazine compounds of the formula (I) or salts thereof,

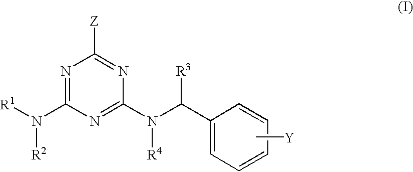

where

Z is hydrogen, hydroxyl, halogen or

(C₁-C₁₀)alkyl, (C₂-C₁₀)alkenyl, (C₂-C₁₀)alkynyl, where each of the three last-mentioned substituents is unsubstituted or substituted by one or more radicals selected from the group consisting of halogen, hydroxyl, amino, mercapto, cyano, nitro, thiocyanato, formyl, (C₁-C₄)alkoxy, mono(C₁-C₄)alkylamino, di(C₁-C₄)alkylamino, (C₁-C₄)haloalkoxy, (C₂-C₄)alkenyloxy, (C₂-C₄)haloalkenyloxy, (C₂-C₄)alkynyloxy, (C₂-C₄)haloalkynyloxy, (C₁-C₄)alkylthio, (C₁-C₄)alkylsulfinyl, (C₁-C₄)haloalkylsulfinyl, (C₁-C₄)alkylsulfonyl, (C₁-C₄)halo-alkylsulfonyl, [(C₁-C₄)alkyl]carbonyl, [(C₁-C₄)haloalkyl]carbonyl, [(C₁-C₄)alkoxy]carbonyl, (C₃-C₉)cycloalkyl, (C₅-C₆)cycloalkenyl, phenyl and heterocyclyl, where each of the 4 last-mentioned radicals is unsubstituted or substituted, preferably unsubstituted or substituted by one or more radicals selected from the group consisting of halogen, cyano, hydroxyl, (C₁-C₄)alkyl, (C₁-C₄)haloalkyl, (C₂-C₄)alkenyl, (C₂-C₄)haloalkenyl, (C₂-C₄)alkynyl, (C₂-C₄)haloalkynyl, (C₁-C₄)alkoxy, (C₁-C₄)haloalkoxy and (C₁-C₄)alkylthio and heterocyclyl preferably contains in each case 3 to 9 ring atoms including 1 to 4 hetero ring atoms selected from the group consisting of N, O and S, or [(C₁-C₆)alkyl]carbonyl, [(C₁-C₆)alkoxy]carbonyl, (C₁-C₆)alkylsulfinyl or (C₁-C₄)alkylsulfonyl, where each of the 4 last-mentioned radicals is unsubstituted or substituted, preferably unsubstituted or substituted by one or more radicals selected from the group consisting of halogen, (C₁-C₄)alkoxy, (C₁-C₄)haloalkoxy and (C₁-C₄)alkylthio, or

(C₃-C₆)cycloalkyl, which is unsubstituted or substituted, (C₅-C₆)cycloalkenyl, which is unsubstituted or substituted, where preferably each of the two last-mentioned cyclic radicals is unsubstituted or substituted by one or more radicals selected from the group consisting of halogen, cyano, (C₁-C₄)alkyl, (C₁-C₄)haloalkyl, (C₂-C₄)alkenyl, (C₂-C₄)alkynyl, (C₁-C₄)alkoxy, (C₁-C₄)haloalkoxy and (C₁-C₄)alkylthio, where the radical Z including substituents has preferably 1 to 30 carbon atoms, in particular from 1 to 20 carbon atoms,

R¹ and R² independently of one another are

H, formyl, (C₁-C₁₀)alkyl, (C₂-C₁₀)alkenyl, (C₂-C₁₀)alkynyl, (C₁-C₁₀)alkylsulfinyl, (C₁-C₁₀)alkylsulfonyl, (C₁-C₁₀)alkoxy, [(C₁-C₁₀)alkyl]carbonyl, [(C₁-C₁₀)alkyl]thiocarbonyl, phenylcarbonyl, naphthylcarbonyl, phenylthiocarbonyl, naphthylthiocarbonyl, [(C₁-C₁₀)alkoxy]carbonyl, [(C₁-C₁₀)alkoxy]thiocarbonyl, aminocarbonyl, mono[(C₁-C₁₀)alkyl]amino-carbonyl, di[(C₁-C₁₀)alkyl]aminocarbonyl, aminothiocarbonyl, mono[(C₁-C₁₀)— alkyl]aminothiocarbonyl or di[(C₁-C₁₀)alkyl]aminothiocarbonyl, where each of the 20 last-mentioned radicals is unsubstituted or substituted, preferably unsubstituted or substituted by one or more radicals selected from the group consisting of halogen, (C₁-C₄)alkoxy, (C₁-C₄)haloalkoxy, (C₁-C₄)hydroxyalkoxy and (C₁-C₄)alkoxy-(C₁-C₄)alkoxy and, in the case of cyclic radicals, also (C₁-C₄)alkyl, (C₁-C₄)haloalkyl, (C₁-C₄)alkoxy-(C₁-C₄)alkyl and (C₁-C₄)hydroxyalkyl,

or

(C₃-C₆)cycloalkyl, (C₅-C₆)cycloalkenyl, (C₃-C₆)cycloalkoxy, (C₅-C₆)cycloalkenyloxy, phenyl, phenoxy, phenylamino, phenylsulfonyl, heterocyclyl, heterocyclyloxy, heterocyclylamino, heterocyclylcarbonyl, heterocyclylsulfonyl, where each of the 13 last-mentioned radicals is unsubstituted or substituted, or preferably unsubstituted or substituted by one or more radicals selected from the group consisting of halogen, cyano, hydroxyl, (C₁-C₄)alkyl, (C₁-C₄)haloalkyl, (C₁-C₄)hydroxyalkyl, (C₁-C₄)alkoxy-(C₁-C₄)alkyl, (C₁-C₄)alkoxy, (C₁-C₄)haloalkoxy, (C₁-C₄)hydroxyalkoxy and (C₁-C₄)alkoxy-(C₁-C₄)alkoxy and heterocyclyl in the radicals mentioned is in each 1O case heterocyclyl having in each case 3 to 9 ring atoms including 1 to 4 hetero ring atoms selected from the group consisting of N, O and S, or one of the radicals R¹ and R² is as defined above and the other of the radicals R¹ and R² is a group of the formula NR′R″, where R′ and R″ independently of one another are H or (C₁-C₆)alkyl, or

R¹ and R² together are (C₁-C₁₀)alkylidene which is unsubstituted or substituted by one or more radicals selected from the group consisting of halogen, cyano, (C₁-C₄)alkoxy, (C₁-C₄)haloalkoxy, (C₁-C₄)monoalkylamino, (C₁-C₄)dialkylamino and (C₁-C₄)alkylthio, or

NR¹R² together are a heterocyclyl radical which has 3 to 6 ring atoms, is attached at the nitrogen atom and, in addition to the nitrogen atom, optionally contains, as hetero ring atom, 1 to 3 further hetero ring atoms selected from the group consisting of N, O and S, the heterocycle being unsubstituted or substituted, preferably unsubstituted or substituted by one or more radicals selected from the group consisting of halogen, cyano, hydroxyl, (C₁-C₄)alkyl, (C₁-C₄)haloalkyl, (C₁-C₄)hydroxyalkyl, (C₁-C₄)alkoxy, (C₁-C₄)haloalkoxy, (C₁-C₄)hydroxyalkoxy, (C₁-C₄)alkoxy-(C₁-C₄)alkoxy, (C₁-C₄)alkoxy-(C₁-C₄)alkyl and oxo, and

R³ is halogen, CN, NO₂, SCN or a radical of the formula —X¹—A¹, where

X¹ is a direct bond or a divalent group of the formula —O—, —S(O)ₚ—, —S(O)ₚ—O—, —O—S(O)P—, —CO—, —O—CO—, —CO—O—, —S—CO—, —CO—S—, —S—CS—, —CS—S—, —O—CO—O—, —NR^{O}—, —O—NR^{O}—, —NR^{O}—O—, —NR^{O}—CO—, —CO—NR^{O}—, —O—CO—NR^{O}— or —NR^{O}—CO—O—, where in each case p is the integer 0, 1 or 2 and R^{O} is hydrogen, (C₁-C₆)alkyl, (C₂-C₆)alkenyl, (C₂-C₆)alkynyl, phenyl, phenyl-(C₁-C₆)alkyl, (C₃-C₆)cycloalkyl or [(C₁-C₆)alkyl]carbonyl, and

A¹ is hydrogen, (C₁-C₁₀)alkyl, (C₂-C₁₀)alkenyl, (C₂-C₁₀)alkynyl, (C₃-C₆)cycloalkyl, (C₅-C₆)cycloalkenyl, phenyl or heterocyclyl having 3 to 9 ring atoms and 1 to 4 hetero ring atoms selected from the group consisting of N, O and S, where each of the 7 last-mentioned radicals is unsubstituted or substituted, preferably unsubstituted or substituted by one or more radicals selected from the group consisting of halogen, cyano, hydroxyl, (C₃-C₆)cycloalkyl, (C₀-C₄)alkoxy, (C₁-C₄)haloalkoxy and (C₁-C₄)hydroxyalkoxy and, in the case of cyclic radicals, also (C₁-C₄)alkyl, (C₁-C₄)haloalkyl, (C₁-C₄)alkoxy-(C₁-C₄)alkyl and (C₁-C₄)hydroxyalkyl and, including substituents, preferably has up to 20 carbon atoms, and

R⁴ is H or formyl, (C₁-C₁₀)alkyl, (C₂-C₁₀)alkenyl, (C₂-C₁₀)alkynyl, (C₁-C₁₀)alkylsulfinyl, (C₁-C₁₀)alkylsulfonyl, (C₁-C₁₀)alkoxy, [(C₁-C₁₀)alkyl]carbonyl, [(C₁-C₁₀)alkoxy]carbonyl, where each of the 8 last-mentioned radicals is unsubstituted or substituted, preferably unsubstituted or substituted by one or more radicals selected from the group consisting of halogen, (C₁-C₄)alkoxy, (C₁-C₄)haloalkoxy and (C₁-C₄)hydroxyalkoxy, or (C₃-C₆)cycloalkyl, (C₅-C₆)cycloalkenyl, (C₃-C₆)cycloalkoxy, (C₅-C₆)cycloalkenyloxy, phenyl, phenoxy, phenylamino, phenylcarbonyl, phenylsulfonyl, heterocyclyl, heterocyclyloxy, heterocyclylamino, heterocyclylcarbonyl or heterocyclylsulfonyl, where each of the 14 last-mentioned radicals is unsubstituted or substituted,

and heterocyclyl in the 5 last-mentioned radicals contains preferably in each case 3 to 9 ring atoms including 1 to 4 hetero ring atoms selected from the group consisting of N, O and S, where preferably each of the 14 radicals mentioned is unsubstituted or substituted by one or more radicals selected from the group consisting of halogen, cyano, hydroxyl, (C₁-C₄)alkyl, (C₁-C₄)haloalkyl, (C₁-C₄)hydroxyalkyl, (C₁-C₄)alkoxy, (C₁-C₄)haloalkoxy and (C₁-C₄)hydroxyalkoxy,

or a group of the formula NR^{a}R^{b}, where R^{a} and R^{b} independently of one another are H, formyl, (C₁-C₆)alkyl, (C₂-C₆)alkenyl, (C₂-C₆)alkynyl, (C₁-C₆)alkylsulfinyl, (C₁-C₆)alkylsulfonyl, (C₁-C₆)alkoxy, (C₁-C₆)alkylcarbonyl or [(C₁-C₆)alkoxy]carbonyl, where each of the 8 last-mentioned groups is unsubstituted or substituted, preferably unsubstituted or substituted by one or more radicals selected from the group consisting of halogen, hydroxyl, (C₁-C₄)alkoxy, (C₁-C₄)haloalkoxy, (C₁-C₄)hydroxyalkoxy and (C₁-C₄)alkoxy-(C₁-C₄)alkoxy, or

R^{a} and R^{b} together are straight-chain (C₂-C₅)alkylene which is unsubstituted or substituted by one or more radicals selected from the group consisting of (C₁-C₄)alkyl, (C₁-C₄)alkoxy, (C₁-C₄)alkoxy-(C₁-C₄)alkyl and oxo, and

Y is halogen, nitro, cyano, thiocyanato or a radical of the formula —X²—A², where

X² is a direct bond or a divalent group of the formula —O—, —S(O)_{q}—, —S(O)_{q}—O—, —O—S(O)_{q}—, —S(O)_{q}—NR^{r}—, —NR^{r}—S(O)_{q}—, —CO— —O—CO—, —CO—O—, —S—CO—, —CO—S—, —S—CS—, —CS—S—, —O—CO—O—, —NR^{r}, —O—NR^{r}—, —NR^{r}—O—, —NR^{r}—CO—, —CO—NR^{r}—, —O—CO—NR^{r}— or —NR^{r}—CO—O—, where in each case q is the integer 0, 1 or 2 and R^{r} is hydrogen, amino, substituted amino, (C₁-C₆)alkyl, (C₂-C₆)alkenyl, (C₂-C₆)alkynyl, phenyl, phenyl-(C₁-C₆)alkyl, phenylcarbonyl, (C₃-C₆)cycloalkyl, (C₅-C₆)cycloalkenyl, [(C₁-C₆)alkyl]-carbonyl, (C₁-C₆)alkylsulfonyl or (C₁-C₆)alkylsulfinyl, phenylsulfonyl or phenylsulfinyl, where each of the 13 last-mentioned radicals is unsubstituted or substituted, preferably unsubstituted or substituted by one or more radicals selected from the group consisting of halogen, cyano, hydroxyl, (C₁-C₄)alkoxy, (C₁-C₄)haloalkoxy and (C₁-C₄)hydroxyalkoxy and, in the case of cyclic radicals, also (C₁-C₄)alkyl, (C₁-C₄)haloalkyl, (C₁-C₄)alkoxy-(C₁-C₄)alkyl and (C₁-C₄)hydroxyalkyl, and

A² is hydrogen, (C₁-C₁₀)alkyl, (C₂-C₁₀)alkenyl, (C₂-C₁₀)alkynyl, (C₃-C₆)cycloalkyl, (C₅-C₆)cycloalkenyl, phenyl or heterocyclyl, where each of the 7 last-mentioned radicals is unsubstituted or substituted, preferably unsubstituted or substituted by one or more radicals selected from the group consisting of halogen, cyano, hydroxyl, amino, aminocarbonyl, mono- and di(C₁-C₆)alkylamino, mono- and diarylamino, N—(C₁-C₆)alkyl-N-arylamino, mono- and diacylamino, N-(C₁-C₆)alkyl-N-acylamino, N-aryl-N-acylamino, (C₁-C₆)alkoxy, (C₁-C₆)alkylthio, (C₁-C₆)alkylsulfonyl, (C₁-C₆)alkylsulfinyl, [(C₁-C₅)alkyl]carbonyl, [(C₁-C₅)alkoxy]carbonyl, [(C₁-C₆)alkyl]carbonyloxy, (C₃-C₆)cycloalkyl, (C₃-C₆)cycloalkoxy, (C₃-C₆)cycloalkylcarbonyl, (C₃-C₆)cycloalkylcarbonyloxy, phenyl, phenoxy, phenylthio, phenylcarbonyl, phenylcarbonyloxy, heterocyclyl, heterocyclyloxy, heterocyclylthio, heterocyclylcarbonyl, heterocyclylcarbonyloxy and, in the case of cyclic radicals, also (C₁-C₆)alkyl, (C₁-C₆)haloalkyl and (C₁-C₄)alkoxy-(C₁-C₆)alkyl, where each of the 34 last-mentioned radicals is unsubstituted or substituted, preferably unsubstituted or substituted by one or more radicals selected from the group consisting of halogen, cyano, hydroxyl, amino, mono- and di(C₁-C₆)alkylamino, mono- and diarylamino, N—(C₁-C₆)alkyl-N-arylamino, mono- and di(C₁-C₆)acylamino, N—(C₁-C₆)alkyl-N-acylamino, (C₁-C₆)alkoxy, (C₁-C₆)alkylthio, (C₃-C₆)cycloalkyl, (C₃-C₆)cycloalkoxy, (C₃-C₆)cycloalkylcarbonyl, (C₃-C₆)cycloalkylcarbonyloxy, phenyl, phenoxy, phenylthio and, in the case of cyclic radicals, also (C₁-C₆)alkyl, (C₁-C₆)haloalkyl and (C₁-C₄)alkoxy-(C₁-C₆)alkyl and where heterocyclyl in A² contains in each case 3 to 9 ring atoms and 1 to 4 hetero ring atoms selected from the group consisting of N, O and S, and where A², including substituents, preferably has up to 20 carbon atoms,

where

the compound of the formula (I) are optically active and not present as racemic compound, i.e. at least one chiral element is present in the (R) and (S) configurations in unequal proportions

and

component (B) is one or more herbicides selected from the group of compounds consisting of

(B1) foliar- and/or soil-acting herbicides which are active against monocotyledonous harmful plants,

(B2) herbicides which are active against predominantly dicotyledonous harmful plants,

(B3) herbicides which are active against monocotyledonous and dicotyledonous harmful plants and

(B4) herbicides which are active against monocotyledonous and dicotyledonous harmful plants and which can be employed specifically in tolerant crops or on non-crop land.

The synergistic effects are observed when the active compounds (A) and (B) are applied jointly; however, they can also frequently be observed when the active compounds are applied at different times (splitting). It is also possible to apply the herbicides or the herbicide combinations in a plurality of portions (sequential application), for example after pre-emergence applications, followed by post-emergence applications or after early post-emergence applications, followed by medium or late post-emergence applications. Preference is given here to the joint or almost simultaneous application of the active compounds of the combination in question.

The synergistic effects permit a reduction of the application rates of the individual active compounds, a higher activity at the same application rate, the control of harmful plants which were as yet uncontrolled (gaps), an extension of the period of application and/or a reduction in the number of individual applications required and—as a result for the user—weed control systems which are more advantageous economically and ecologically.

The combinations according to the invention of (A)+(B) permit, for example, synergistic increases in activity which, in an unexpected manner, exceed the activities which are achieved with the individual active compounds (A) and (B).

The formula (I) comprises all stereoisomers and mixtures thereof with the additional condition that the compound (I) comprises, with respect to the configuration at a carbon atom, for example, the benzylic carbon atom on the amino group of the triazine, as optically active compound in the form of a pure stereoisomer having the R- or the S-configuration at this center or in the form of a mixture of stereoisomers which, with respect to the configuration at the center mentioned, comprises the R— or the S-configuration in enriched form.

The stereoisomers may have other centers of chirality or other centers of asymmetry in the molecule in question, for example in the radicals R¹, R², R³, R⁴ and in the radical Y. If this is not the case, the compounds of the formula (I) are pure enantiomers or enantiomer mixtures in which one of the enantiomers is present in excess, measurable, for example, by a specific rotation of the polarized light (optical rotadispersion) which is different from zero or by other methods for determining the enantiomeric excess (ee %=enantiomeric excess in percent), for example by chromatography on chiral separation media (cf. standard works on stereochemistry).

Further centers of asymmetry in the compound (I) can be asymmetrically substituted carbon atoms or else double bonds which are not specifically mentioned in the general formula (I). The possible stereoisomers, such as enantiomers, diastereomers, Z and E isomers, defined by their specific spatial form are all included in the formula (I). In principle, the stereoisomers can be obtained by customary methods from mixtures of the stereoisomers, or else they can be prepared by stereoselective reactions in combination with the use of stereochemically pure or enriched starting materials. Compounds (I) which are substantially enantiomerically pure can also be obtained by separating racemates by customary methods, for example by crystallization or chiral chromatography.

With respect to the configuration at a center of chirality, the optically active compounds are present as a pure stereoisomer (having the R or S configuration) or as a mixture of the R and S stereoisomers where one of the stereoisomers is present in excess, preferably having a content of R or S isomer of from 60 to 100%, in particular from 70 to 100%, very particularly from 80 to 100%, very preferably from 90 to 100%, based on the total amount of the R and S isomers. In each case, the biologically more active enantiomer or the biologically more active enantiomers are employed with preference.

The compounds of the formula (I) can form salts by addition of a suitable inorganic or organic acid, such as, for example, HCl, HBr, H₂SO₄ or HNO₃, but also oxalic acid or sulfonic acids, to a basic group, such as, for example, amino or alkylamino. Suitable substituents which are present in deprotonated form, such as, for example, sulfonic acids or carboxylic acids, can form inner salts with groups which for their part can be protonated, such as amino groups. Salts can also be formed by replacing the hydrogen of suitable substituents, such as, for example, sulfonic acids or carboxylic acids, by an agriculturally suitable cation. These salts are, for example, metal salts, in particular alkali metal salts or alkaline earth metal salts, in particular sodium salts and potassium salts, or else ammonium salts or salts with organic amines.

In the formula (I) and all the formulae hereinbelow, the radicals alkyl, alkoxy, haloalkyl, haloalkoxy, alkylamino and alkylthio and the corresponding unsaturated and/or substituted radicals can in each case be straight-chain or branched in the carbon skeleton. Unless specifically mentioned otherwise, the lower carbon skeletons, for example with 1 to 6 carbon atoms or in the case of unsaturated groups with 2 to 6 carbon atoms, are preferred for these radicals. Alkyl radicals, also in the composed meanings, such as alkoxy, haloalkyl, and the like, are, for example, methyl, ethyl, n- or isopropyl, n-, i-, t- or 2-butyl, pentyls, hexyls, such as n-hexyl, isohexyl and 1,3-dimethylbutyl, heptyls, such as n-heptyl, 1-methylhexyl and 1,4-dimethylpentyl; alkenyl and alkynyl radicals have the meaning of the possible unsaturated radicals which correspond to the alkyl radicals; alkenyl is, for example, allyl, 1-methylprop-2-en-1-yl, 2-methylprop-2-en-1-yl, but-2-en-1-yl, but-3-en-1-yl, 1-methyl-but-3-en-1-yl and 1-methylbut-2-en-1-yl; alkenyl also includes in particular straight-chain or branched hydrocarbon radicals having more than one double bond, such as 1,3-butadienyl and 1,4-pentadienyl, and also allenyl or cumenyl radicals having one or more cumulated double bonds, such as, for example, allenyl (1,2-propadienyl), 1,2-butadienyl and 1,2,3-pentatrienyl; alkynyl is, for example, propargyl, but-2-yn-1-yl, but-3-yn-1-yl, 1-methylbut-3-yn-1-yl. Alkynyl also includes in particular straight-chain or branched hydrocarbon radicals having more than one triple bond or else having one or more triple bonds and one or more double bonds, such as, for example, 1,3-butatrienyl or 3-penten-1-yn-1-yl.

Alkylidene, for example in the form (C₁-C₁₀)alkylidene, is the radical of a straight-chain or branched alkane which is attached via a double bond, the position of the binding site not yet being fixed. In the case of a branched alkane, the only possible positions are, of course, those where two hydrogen atoms can be replaced by the double bond; examples of radicals are ═CH₂, ═CH—CH₃, ═C(CH₃)—CH₃, ═C(CH₃)—C₂H₅ or ═C(C₂H₅)—C₂H₅.

Cycloalkyl is a carbocyclic saturated ring system having preferably 3-8 carbon atoms, for example cyclopropyl, cyclobutyl, cyclopentyl or cyclohexyl. In the case of substituted cycloalkyl, this includes cyclic systems with substituents, where the substituents are attached to the cycloalkyl radical via a double bond, for example an alkylidene group such as methylidene. Substituted cycloalkyl also includes polycyclic aliphatic systems, such as, for example, bicyclo[1.1.0]butan-1-yl, bicyclo[1.1.0]butan-2-yl, bicyclo[21.0]pentan-1-yl, bicyclo[21.0]pentan-2-yl, bicyclo[2.1.0]pentan-5-yl, adamantan-1-yl and adamantan-2-yl.

Cycloalkenyl is a carbocyclic non-aromatic, partially unsaturated ring system having preferably 4-8 carbon atoms, for example 1-cyclobutenyl, 2-cyclobutenyl, 1-cyclopentenyl, 2-cyclopentenyl, 3-cyclopentenyl, or 1-cyclohexenyl, 2-cyclohexenyl, 3-cyclohexenyl, 1,3-cyclohexadienyl or 1,4-cyclohexadienyl. For substituted cycloalkenyl, the illustrations for substituted cycloalkyl apply correspondingly.

Halogen is, for example, fluorine, chlorine, bromine or iodine. Haloalkyl, -alkenyl and -alkynyl are alkyl, alkenyl and alkynyl, respectively, which are partially or fully substituted by halogen, preferably by fluorine, chlorine and/or bromine, in particular by fluorine or chlorine, for example, monohaloalkyl, perhaloalkyl, CF₃, CHF₂, CH₂F, CF₃CF₂, CH₂FCHCl, CCl₃, CHCl₂, CH₂CH₂Cl; haloalkoxy is, for example, OCF₃, OCHF₂, OCH₂F, CF₃CF₂O, OCH₂CF₃ and OCH₂CH₂Cl; this applies correspondingly to haloalkenyl and other halogen-substituted radicals.

Aryl is a mono-, bi- or polycyclic aromatic system, for example phenyl, naphthyl, tetrahydronaphthyl, indenyl, indanyl, pentalenyl, fluorenyl and the like, preferably phenyl.

A heterocyclic radical or ring (heterocyclyl) can be saturated, unsaturated or heteroaromatic; unless defined otherwise, it preferably contains one or more, in particular 1, 2 or 3, heteroatoms in the heterocyclic ring, preferably selected from the group consisting of N, O and S; it is preferably an aliphatic heterocyclyl radical having 3 to 7 ring atoms or a heteroaromatic radical having 5 or 6 ring atoms. The heterocyclic radical can, for example, be a heteroaromatic radical or ring (heteroaryl), such as, for example, a mono-, bi- or polycyclic aromatic system, in which at least 1 ring contains one or more heteroatoms. It is preferably a heteroaromatic ring having one heteroatom selected from the group consisting of N, O and S, for example pyridyl, pyrrolyl, thienyl or furyl; furthermore, preferably, it is a corresponding heteroaromatic ring having 2 or 3 heteroatoms, for example pyrimidinyl, pyridazinyl, pyrazinyl, triazinyl, thiazolyl, thiadiazolyl, oxazolyl, isoxazolyl, pyrazolyl, imidazolyl and triazolyl. Furthermore preferably, it is a partially or fully hydrogenated heterocyclic radical having one heteroatom selected from the group consisting of N, O and S, for example oxiranyl, oxetanyl, oxolanyl (=tetrahydrofuryl), oxanyl, pyrrolidyl or piperidyl.

Furthermore preferably, it is a partially or fully hydrogenated heterocyclic radical having 2 heteroatoms selected from the group consisting of N, O and S, for example piperazinyl, dioxolanyl, oxazolinyl, isoxazolinyl, oxazolidinyl, isoxazolidinyl and morpholinyl.

Possible substituents for a substituted heterocyclic radical are the substituents mentioned further below, and additionally also oxo. The oxo group can also be present at the hetero ring atoms which can exist in different oxidation states, for example at N and S.

Substituted radicals, such as a substituted alkyl, alkenyl, alkynyl, aryl, phenyl, benzyl, heterocyclyl and heteroaryl radical, are, for example, a substituted radical derived from the unsubstituted skeleton, where the substituents are, for example, one or more, preferably 1, 2 or 3, radicals selected from the group consisting of halogen, alkoxy, haloalkoxy, alkylthio, hydroxyl, amino, nitro, carboxyl, cyano, azido, alkoxycarbonyl, alkylcarbonyl, formyl, carbamoyl, mono- and dialkylaminocarbonyl, substituted amino, such as acylamino, mono- and dialkylamino, and alkylsulfinyl, haloalkylsulfinyl, alkylsulfonyl, haloalkylsulfonyl and, in the case of cyclic radicals, also alkyl, haloalkyl alkylthioalkyl, alkoxyalkyl, optionally substituted mono- and dialkylaminoalkyl and hydroxyalkyl; the term “substituted radicals”, such as substituted alkyl and the like, includes as substituents, in addition to the saturated hydrocarbon-containing radicals mentioned, corresponding unsaturated aliphatic and aromatic radicals, such as unsubstituted or substituted alkenyl, alkynyl, alkenyloxy, alkynyloxy, phenyl, phenoxy etc. Substituted cyclic radicals having aliphatic moieties in the ring include cyclic systems having substituents which are attached to the ring via a double bond, for example those substituted by an alkylidene group, such as methylidene or ethylidene.

Among the radicals with carbon atoms, preference is given to those having 1 to 4 carbon atoms, in particular 1 or 2 carbon atoms. In general, preference is given to substituents selected from the group consisting of halogen, for example fluorine and chlorine, (C₁-C₄)alkyl, preferably methyl or ethyl, (C₁-C₄)haloalkyl, preferably trifluoromethyl, (C₁-C₄)alkoxy, preferably methoxy or ethoxy, (C₁-C₄)haloalkoxy, nitro and cyano. Particular preference is given here to the substituents methyl, methoxy, fluorine and chlorine.

Substituted amino, such as mono- or disubstituted amino, is a radical from the group of the substituted amino radicals which are N-substituted, for example, by one or two identical or different radicals selected from the group consisting of alkyl, alkoxy, acyl and aryl; preferably mono- and dialkylamino, mono- and diarylamino, acylamino, N-alkyl-N-arylamino, N-alkyl-N-acylamino and N-heterocycles; preference is given to alkyl radicals having 1 to 4 carbon atoms; aryl is preferably phenyl or substituted phenyl; for acyl, the definition mentioned further below applies, preferably (C₁-C₄)alkanoyl. This applies correspondingly to substituted hydroxylamino or hydrazino.

Unsubstituted or substituted phenyl is preferably phenyl which is unsubstituted or mono- or polysubstituted, preferably up to trisubstituted, by identical or different radicals selected from the group consisting of halogen, (C₁-C₄)alkyl, (C₁-C₄)alkoxy, (C₁-C₄)haloalkyl, (C₁-C₄)haloalkoxy and nitro, for example o-, m- and p-toyl, dimethylphenyls, 2-, 3- and 4-chlorophenyl, 2-, 3- and 4-trifluoro- and -trichlorophenyl, 2,4-, 3,5-, 2,5- and 2,3-dichlorophenyl, o-, m- and p-methoxyphenyl.

Acyl is a radical of an organic acid which is formally formed by removing a hydroxyl group from the acid function, where the organic radical in the acid can also be attached to the acid function via a heteroatom. Examples of acyl are the radical —CO—R of a carboxylic acid HO—CO—R and radicals of acids derived therefrom, such as thiocarbonic acid, unsubstituted or N-substituted iminocarboxylic acids or the radical of carbonic monoesters, N-substituted carbamic acid, sulfonic acids, sulfinic acids, N-substituted sulfonamide acids, phosphonic acids, phosphinic acids.

Acyl is, for example, formyl, alkylcarbonyl, such as [(C₁-C₄)alkyl]carbonyl, phenylcarbonyl, alkyloxycarbonyl, phenyloxycarbonyl, benzyloxycarbonyl, alkylsulfonyl, alkylsulfinyl, N-alkyl-1-iminoalkyl and other radicals of organic acids. The radicals can in each case be further substituted in the alkyl or phenyl moiety, for example in the alkyl moiety by one or more radicals selected from the group consisting of halogen, alkoxy, phenyl and phenoxy; examples of substituents in the phenyl moiety are the substituents which have already been mentioned further above generally for substituted phenyl.

Acyl is preferably an acyl radical in the more restricted sense, i.e. a radical of an organic acid where the acid group is directly attached to the carbon atom of an organic radical, for example formyl, alkylcarbonyl, such as acetyl or [(C₁-C₄)alkyl]carbonyl, phenylcarbonyl, alkylsulfonyl, alkylsulfinyl and other radicals of organic acids.

In particular for reasons of better herbicidal activity, increased synergistic effects, of better selectivity and/or better stability in coformulations, those herbicide combinations according to the invention are of particular interest in which the components (A) and/or (B) mentioned below are used. Particular preference is given to those in which one of the components (A) and (B) is one of the preferred components mentioned, in particular to those in which preferred components (A) and (B) are combined.

Of particular interest are herbicide combinations comprising one or more aminotriazines of the formula (I) or salts thereof as component (A), where

Z is hydrogen, halogen or

(C₁-C₆)alkyl, (C₂-C₆)alkenyl, (C₂-C₆)alkynyl, where each of the three last-mentioned substituents is unsubstituted or substituted by one or more radicals selected from the group consisting of halogen, cyano, formyl, (C₁-C₄)alkoxy, mono(C₁-C₄)alkylamino, di(C₁-C₄)alkylamino, (C₁-C₄)haloalkoxy, (C₁-C₄)alkylsulfonyl, (C₁-C₄)haloalkylsulfonyl, [(C₁-C₄)alkyl]carbonyl, [(C₁-C₄)alkoxy]carbonyl, (C₃-C₆)cycloalkyl, (C₅-C₆)cycloalkenyl and phenyl, where each of the 3 last-mentioned radicals is unsubstituted or substituted by one or more radicals selected from the group consisting of halogen, cyano, (C₁-C₄)alkyl, (C₁-C₄)haloalkyl, (C₁-C₄)alkoxy, (C₁-C₄)haloalkoxy and (C₁-C₄)alkylthio, or

(C₃-C₆)cycloalkyl which is unsubstituted or substituted by one or more radicals selected from the group consisting of halogen, cyano, (C₁-C₄)alkyl, (C₁-C₄)haloalkyl, (C₁-C₄)alkoxy, (C₁-C₄)haloalkoxy and (C₁-C₄)alkylthio.

Z is preferably (C₁-C₆)alkyl which is unsubstituted or substituted by one or more radicals selected from the group consisting of halogen, (C₃-C₆)cycloalkyl and phenyl, where each of the 2 last-mentioned radicals is unsubstituted or substituted by one or more radicals selected from the group consisting of halogen, (C₁-C₄)alkyl, (C₁-C₄)haloalkyl, (C₁-C₄)alkoxy, (C₁-C₄)haloalkoxy and (C₁-C₄)alkylthio, or (C₃-C₆)cycloalkyl which is unsubstituted or substituted by one or more radicals selected from the group consisting of halogen, (C₁-C₄)alkyl, (C₁-C₄)haloalkyl, (C₁-C₄)alkoxy, (C₁-C₄)haloalkoxy and (C₁-C₄)alkylthio.

Z is in particular (C₁-C₄)alkyl, such as, for example, methyl, ethyl, n-propyl and isopropyl, or (C₁-C₄)haloalkyl, such as, for example, 1-fluoroisopropyl, 1-fluoroethyl, 1-fluoropropyl, CF₃ and CCl₃, or cyclopropyl, cyclobutyl, cyclopentyl, cyclohexyl, 1-methylcyclopropyl, 1-methylcyclobutyl, 1-methylcyclopentyl, 1-methylcyclohexyl or benzyl.

Of particular interest are herbicide combinations comprising one or more aminotriazines of the formula (I) or salts thereof as component (A), where

R¹ and R² independently of one another are

H, formyl, (C₁-C₆)alkyl, (C₂-C₆)alkenyl, (C₂-C₆)alkynyl, (C₁-C₆)alkylsulfinyl, (C₁-C₆)alkylsulfonyl, (C₁-C₆)alkoxy, [(C₁-C₆)alkyl]carbonyl, [(C₁-C₆)alkyl]thiocarbonyl, phenylcarbonyl, naphthylcarbonyl, phenylthiocarbonyl, naphthylthiocarbonyl, [(C₁-C₆)alkoxy]carbonyl, [(C₁-C₆)alkoxy]thiocarbonyl, aminocarbonyl, mono[(C₁-C₆)alkyl]aminocarbonyl, di[(C₁-C₆)alkyl]aminocarbonyl, aminothiocarbonyl, mono[(C₁-C₆)alkyl]aminothiocarbonyl or di[(C₁-C₆)alkyl]aminothiocarbonyl, where each of the 20 last-mentioned radicals is unsubstituted or substituted, preferably unsubstituted or substituted by one or more radicals selected from the group consisting of halogen, (C₁-C₄)alkoxy, (C₁-C₄)haloalkoxy, (C₁-C₄)hydroxyalkoxy and (C₁-C₄)alkoxy-(C₁-C₄)alkoxy and, in the case of cyclic radicals, also (C₁-C₄)alkyl, (C₁-C₄)haloalkyl, (C₁-C₄)alkoxy-(C₁-C₄)alkyl and (C₁-C₄)hydroxyalkyl,

or

(C₃-C₆)cycloalkyl, phenyl, where each of the 2 last-mentioned radicals is unsubstituted or substituted, preferably unsubstituted or substituted by one or more radicals selected from the group consisting of halogen, cyano, (C₁-C₄)alkyl, (C₁-C₄)haloalkyl, (C₁-C₄)alkoxy-(C₁-C₄)alkyl, (C₁-C₄)alkoxy, (C₁-C₄)haloalkoxy and (C₁-C₄)alkoxy-(C₁-C₄)alkoxy, or one of the radicals R¹ and R² is as defined above and the other of the radicals R¹ and R² is a group of the formula NR′R″, where R′ and R″ independently of one another are H or (C₁-C₄)alkyl, or

R¹ and R² together are (C₁-C₆)alkylidene which is unsubstituted or substituted by one or more radicals selected from the group consisting of halogen, cyano, (C₁-C₄)alkoxy, (C₁-C₄)haloalkoxy, (C₁-C₄)monoalkylamino, (C₁-C₄)dialkylamino and (C₁-C₄)alkylthio, or

NR¹R² together are a heterocyclyl radical having 3 to 6 ring atoms which is attached at the nitrogen atom and contains the nitrogen atom as hetero ring atom.

Preferably,

R¹ is hydrogen or (C₁-C₄)alkyl, in particular H, and

R² is hydrogen, formyl, aminocarbonyl, aminothiocarbonyl, (C₁-C₄)alkyl, (C₁-C₄)alkylsulfonyl, [(C₁-C₄)alkyl]carbonyl, [(C₁-C₄)alkoxy]carbonyl, where each of the 4 last-mentioned radicals is unsubstituted or substituted by one or more radicals selected from the group consisting of halogen and (C₁-C₄)alkoxy, or (C₃-C₆)cycloalkyl which is unsubstituted or substituted by one or more radicals selected from the group consisting of halogen, (C₁-C₄)alkyl and (C₁-C₄)haloalkyl, or

R¹ and R² together are (C₁-C₆)alkylidene which is unsubstituted or substituted by one or more radicals selected from the group consisting of halogen and cyano, in particular hydrogen.

Of particular interest are herbicide combinations comprising one or more aminotriazines of the formula (I) or salts thereof as component (A), where

R³ is halogen, CN, NO₂, SCN or a radical of the formula —X¹—A¹, where

X¹ is a direct bond or a divalent group of the formula —O—, —S(O)ₚ—, —S(O)ₚ—O—, —O—S(O)ₚ—, —CO—, —O—CO—, —CO—O—, —S—CO—, —CO—S—, —S—CS—, —CS—S—, —O—CO—O—, —NR^{O}—, —O—NR^{O}—, —NR^{O}—O—, —NR^{O}—CO—, —CO—NR^{O}—, —O—CO—NR^{O}— or —NR^{O}—CO—O—, preferably —O—, —S(O)ₚ—, —CO—, —O—CO—, —CO—O—, —S—CO—, —CO—S—, —NR^{O}—, —O—NR^{O}—, —NR^{O}—O—, —NR^{O}—CO—, —CO—NR^{O}—, —O—CO—NR^{O}— or —NR^{O}—CO—O—, where in each case p is the integer 0, 1 or 2 and R^{O} is hydrogen, (C₁-C₄)alkyl, (C₂-C₄)alkenyl, (C₂-C₄)alkynyl, phenyl, phenyl-(C₁-C₂)alkyl, (C₃-C₆)cycloalkyl or [(C₁-C₄)alkyl]carbonyl, and

A¹ is hydrogen, (C₁-C₆)alkyl, (C₂-C₆)alkenyl, (C₂-C₆)alkynyl, (C₃-C₆)cycloalkyl, phenyl or heterocyclyl having 3 to 9 ring atoms and 1 to 3 hetero ring atoms selected from the group consisting of N, O and S, where each of the 6 last-mentioned radicals is unsubstituted or substituted, preferably unsubstituted or substituted by one or more radicals selected from the group consisting of halogen, cyano, (C₁-C₄)alkyl, (C₃-C₆)cycloalkyl, (C₁-C₄)alkoxy, (C₁-C₄)haloalkoxy, (C₁-C₄)alkylthio and, in the case of cyclic radicals, also (C₁-C₄)haloalkyl and (C₁-C₄)alkoxy(C₁-C₄)alkyl and, including substituents, preferably has up to 16 carbon atoms.

Preferably, R³═H, (C₁-C₄)alkyl, preferably methyl or ethyl, or cyclopropyl, cyclobutyl, cyclopentyl, cyclohexyl or phenyl, where each of the 8 last-mentioned radicals is unsubstituted or substituted by one or more radicals selected from the group consisting of halogen and (C₁-C₂)alkoxy and, in the case of cyclic radicals, also (C₁-C₂)alkyl, (C₁-C₂)haloalkyl and (C₁-C₄)alkoxy-(C₁-C₄)alkyl.

Of particular interest are herbicide combinations comprising one or more aminotriazines of the formula (I) or salts thereof as component (A) where

R⁴ is H or formyl, (C₁-C₆)alkyl, (C₂-C₆)alkenyl, (C₂-C₆)alkynyl, (C₁-C₆)alkylsulfinyl, (C₁-C₆)alkylsulfonyl, (C₁-C₆)alkoxy, [(C₁-C₆)alkyl]carbonyl, [(C₁-C₆)alkoxy]carbonyl, where each of the 8 last-mentioned radicals is unsubstituted or substituted by one or more radicals selected from the group consisting of halogen, (C₁-C₄)alkoxy, (C₁-C₄)haloalkoxy and (C₁-C₄)hydroxyalkoxy, or

a group of the formula NR^{a}R^{b}, where R^{a} and R^{b} independently of one another are H or (C₁-C₄)alkyl. R⁴ is in particular hydrogen.

Of particular interest are herbicide combinations comprising one or more aminotriazines of the formula (I) or salts thereof as component (A) where

Y is halogen, nitro, cyano, thiocyanato or a radical of the formula —X²—A², where

X² is a direct bond or a divalent group of the formula —O—, —S(O)_{q}—, —S(O)_{q}—O—, —O—S(O)_{q}—, —S(O)_{q}—NR^{r}—, —NR^{r}—S(O)_{q}—, —CO—, —O—CO—, —CO—O—, —S—CO—, —CO—S—, —S—CS—, —CS—S—, —O—CO—O—, —NR^{r}—, —O—NR^{r}—, —NR^{r}—O—, —NR^{r}—CO—, —CO—NR^{r}—, —O—CO—NR^{r}— or —NR^{r}—CO—O—, preferably —O—, —S(O)_{q}—, —S(O)_{q}—O—, —S(O)_{q}—NR^{r}—, —NR^{r}—S(O)_{q}—, —CO—, —O—CO—, —CO—O—, —S—CO—, —CO—S—, —NR^{r}—, —O—NR^{r}—, —NR^{r}—O—, —NR^{r}—CO—, —CO—NR^{r}—, —O—CO—NR^{r}— or —NR^{r}—CO—O—, where in each case q is the integer 0, 1 or 2 and R^{r} in each case independently of one another are hydrogen, amino, mono- or di(C₁-C₄)— alkylamino, mono- or di(C₁-C₄)arylamino, N—(C₁-C₄)alkyl-N-arylamino, (C₁-C₄)alkyl, (C₂-C₄)alkenyl, (C₂-C₄)alkynyl, phenyl, phenyl-(C₁-C₄)alkyl, phenylcarbonyl, (C₃-C₆)-cycloalkyl, (C₅-C₆)cycloalkenyl, [(C₁-C₄)alkyl]carbonyl, (C₁-C₄)alkylsulfonyl, (C₁-C₄)-alkylsulfinyl, phenylsulfonyl or phenylsulfinyl, where each of the 18 last-mentioned radicals is unsubstituted or substituted, preferably unsubstituted or substituted by one or more radicals selected from the group consisting of halogen, cyano, (C₁-C₄)alkyl, (C₁-C₄)alkoxy, (C₁-C₄)haloalkoxy and, in the case of cyclic radicals, also (C₁-C₄)haloalkyl and (C₁-C₄)alkoxy-(C₁-C₄)alkyl, and

A² is hydrogen, (C₁-C₆)alkyl, (C₂-C₆)alkenyl, (C₂-C₆)alkynyl, (C₃-C₆)cycloalkyl, (C₅-C₆)cycloalkenyl, phenyl or heterocyclyl having 3 to 6 ring atoms and 1 to 3 hetero ring atoms selected from the group consisting of N, O and S, where each of the 7 last-mentioned radicals is unsubstituted or substituted, preferably unsubstituted or substituted by one or more radicals selected from the group consisting of halogen, cyano, hydroxyl, amino or else mercapto or aminocarbonyl, mono- and di-(C₁-C₄)alkylamino, mono- and diphenylamino, N—(C₁-C₄)alkyl-N-phenylamino, mono- and di[(C₁-C₄)alkanoyl]amino, mono- and di[(C₁-C₄)alkylsulfonyl]amino, N-(C₁-C₄)alkyl-N-[(C₁-C₄)alkanoyl]amino, (C₁-C₄)alkyl-N-[(C₁-C₄)alkylsulfonyl]amino, N-phenyl-N-[(C₁-C₄)alkanoyl]amino, N-phenyl-N-[(C₁-C₄)alkylsulfonyl]amino, (C₁-C₄)alkoxy, (C₁-C₄)alkylthio, (C₁-C₄)alkylsulfonyl, (C₁-C₄)alkylsulfinyl, [(C₁-C₄)alkyl]carbonyl, [(C₁-C₄)alkoxy]carbonyl, [(C₁-C₄)alkyl]carbonyloxy, (C₃-C₆)cycloalkyl, (C₃-C₆)cycloalkoxy, (C₃-C₆)cycloalkylcarbonyl, (C₃-C₆)cycloalkylcarbonyloxy, phenyl, phenoxy, phenylthio, phenylcarbonyl, phenylcarbonyloxy, heterocyclyl, heterocyclyloxy, heterocyclylthio, heterocyclylcarbonyl, heterocyclylcarbonyloxy and, in the case of cyclic radicals, also (C₁-C₆)alkyl,

where each of the 35 last-mentioned radicals is unsubstituted or substituted, preferably unsubstituted or substituted by one or more radicals selected from the group consisting of halogen, cyano, hydroxyl, amino, mono- and di(C₁-C₄)alkylamino, mono- and diphenylamino, N—(C₁-C₄)alkyl-N-phenylamino, (C₁-C₄)alkoxy, (C₁-C₄)alkylthio, (C₃-C₆)cycloalkyl, (C₃-C₆)cycloalkoxy, phenyl, phenoxy and phenylthio and, in the case of cyclic radicals, also (C₁-C₄)alkyl, (C₁-C₄)haloalkyl and (C₁-C₄)alkoxy-(C₁-C₄)alkyl and A², including substituents, preferably has up to 16 carbon atoms.

Y is preferably hydrogen, halogen, hydroxyl, amino, nitro, formyl, aminocarbonyl, carboxyl, cyano, thiocyanato or else aminosulfonyl or (C₁-C₆)alkyl, (C₁-C₆)alkoxy, (C₁-C₆)alkylthio, (C₁-C₄)alkylsulfonyl, (C₁-C₄)alkylsulfinyl, (C₂-C₆)alkenyl, (C₂-C₆)alkynyl, (C₁-C₆)alkylcarbonyl, (C₁-C₆)alkoxycarbonyl, (C₁-C₆)alkylcarbonyloxy, mono- or di-[(C₁-C₄)alkyl]amino, mono- and diphenylamino, N—(C₁-C₄)alkyl-N-phenylamino or else mono- or di [(C₁-C₄)alkyl]aminosulfonyl, mono- or di[(C₁-C₆)alkanoyl]amino, N-[(C₁-C₆)alkanoyl]-N-[(C₁-C₄)alkyl]amino, N-phenyl-N-[(C₁-C₄)alkanoyl]amino, mono- or di-[(C₁-C₆)alkylsulfonyl]amino, N-[(C₁-C₆)alkylsu lfonyl]-N-[(C₁-C₄)alkyl]amino, N-phenyl-N-[(C₁-C₄)alkylsulfonyl]amino,

where each of the 24 last-mentioned radicals is substituted by one or more radicals selected from the group consisting of halogen, nitro, amino, mono- and di[(C₁-C₄)alkyl]amino, mono- and diphenylamino, N-(C₁-C₄)alkyl-N-phenylamino, hydroxyl, cyano, (C₁-C₄)alkoxy or else mercapto or (C₁-C₄)alkylthio, (C₁-C₄)haloalkoxy, (C₁-C₄)alkylcarbonyl, (C₁-C₄)alkoxycarbonyl, (C₃-C₆)cycloalkyl, (C₃-C₆)cycloalkylcarbonyl, (C₃-C₆)cycloalkylcarbonyloxy, phenyl, phenoxy, phenylthio, phenylcarbonyl, phenoxycarbonyl, phenylcarbonyloxy, phenylsulfonyl, where the 7 last-mentioned radicals are unsubstituted or optionally substituted in the phenyl radical, or

(C₃-C₆)cycloalkyl, (C₃-C₆)cycloalkoxy, (C₃-C₆)cycloalkylcarbonyl, phenyl, phenoxy, phenylthio, phenylcarbonyl, phenoxycarbonyl, phenylcarbonyloxy or phenylsulfonyl, heterocyclyl, heterocyclyloxy, heterocyclylthio, heterocyclylcarbonyl, heterocyclyl-carbonyloxy, where each of the 14 last-mentioned radicals is unsubstituted or substituted by one or more radicals selected from the group consisting of halogen, nitro, amino, (C₁-C₄)alkyl, mono- and di[(C₁-C₄)alkyl]amino, mono- and diphenylamino, N—(C₁-C₄)alkyl-N-phenylamino, hydroxyl, cyano, (C₁-C₄)alkoxy, (C₁-C₄)alkylthio, (C₁-C₄)haloalkoxy, (C₁-C₄)alkylcarbonyl, (C₁-C₄)alkoxycarbonyl.

More preferred, Y=hydrogen, halogen, hydroxyl, amino, nitro, formyl, carboxyl, cyano, (C₁-C₆)alkyl, (C₁-C₄)alkoxy, halo-(C₁-C₄) alkyl, halo-(C₁-C₄)alkoxy, hydroxy-(C₁-C₄)alkyl, hydroxy-(C₁-C₄)alkoxy, (C₁-C₄)alkoxy-(C₁-C₄)alkyl, halo-(C₁-C₄)alkoxy-(C₁-C₄)alkyl, halo-(C₁-C₄)alkoxy-(C₁-C₄)alkoxy, (C₁-C₄)alkoxy-(C₁-C₄)alkoxy, (C₃-C₆)cycloalkyl, halo-(C₃-C₆)cycloalkyl, (C₂-C₄)alkenyl, halo-(C₂-C₄)alkenyl, (C₂-C₄)alkynyl, halo-(C₂-C₄)alkynyl, (C₁-C₄)alkylcarbonyl, (C₁-C₄)alkoxycarbonyl or else (C₁-C₄)alkylsulfonyl or else (C₁-C₄)alkylsulfinyl or else (C₁-C₄)alkylaminosulfonyl or else di[(C₁-C₄)alkyl]aminosulfonyl or (C₁-C₄)alkylcarbonyl-(C₁-C₄)alkyl, (C₁-C₄)— alkylcarbonyloxy, (C₁-C₄)alkylthio-(C₁-C₄)alkyl, mercapto-(C₁-C₄)alkyl, amino-(C₁-C₄)— alkyl, (C₁-C₄)alkylamino, (C₁-C₄)alkylamino-(C₁-C₄)alkyl, di[(C₁-C₄)alkyl]amino, di-[(C₁-C₄)alkyl]amino-(C₁-C₄)alkyl, (C₁-C₄)alkanoylamino, (C₁-C₄)alkylsulfonylamino, di[(C₁-C₄)alkanoyl]amino, di[(C₁-C₄)alkylsulfonyl]amino or

phenyl, phenoxy, phenylcarbonyl, phenoxycarbonyl, phenylcarbonyloxy, phenoxy-(C₁-C₄)alkyl, phenylcarbonyl-(C₁-C₄)alkyl, phenyl-(C₁-C₄)alkyl or one of the 8 last-mentioned radicals which is substituted in the phenyl moiety by one or more radicals selected from the group consisting of halogen, (C₁-C₄)alkyl, (C₁-C₄)alkoxy, (C₁-C₄)haloalkyl and (C₁-C₄)haloalkoxy and also hydroxyl.

More preferably, Y=hydrogen, hydroxyl, amino, nitro, formyl, carboxyl, cyano, fluorine, chlorine, bromine, iodine, methyl, ethyl, n-propyl, isopropyl, n-butyl, isobutyl, tert-butyl, sec-butyl, methoxy, ethoxy, n-propoxy, isopropoxy, CF₃, CHF₂, CH₂F, CCl₃, OCHF₂, OCF₃, OCH₂F, CH₂NH₂, CH₂CH₂NH₂, CH₂OH, CH₂CH₂OH, CH₂SH, CH₂CH₂SH, OCH₂CH₂OH, OCH(CH₃)OH, CH₂OCH₃, CH₂OC₂H₅, CH₂CH₂OCH₃, CH₂CH₂OC₂H₅, OCH₂OCH₃, OCH₂OC₂H₅, OCH₂CH₂OCH₃, OCH₂CH₂OC₂H₅, cyclopropyl, cyclobutyl, cyclopentyl, cyclohexyl, 1-fluorocyclopropyl, vinyl, allyl, 1-propenyl, 1-methyl-1-propenyl, 1-ethyl-1-propenyl, but-1-enyl, but-2-en-1-yl, but-3-en-1-yl, ethynyl, propargyl, prop-1-yn-1-yl, but-1-yn-1-yl, but-2-yn-1-yl, but-3-yn-1-yl, 1-methylprop-1-yn-1-yl, acetyl, propionyl, propylcarbonyl, methylsulfonyl, ethylsulfonyl, methylsulfinyl, ethylsulfinyl, aminosulfonyl, methylaminosulfonyl, ethylaminosulfonyl, propylaminosulfonyl, isopropylaminosulfonyl, dimethylaminosulfonyl, diethylaminosulfonyl, methoxycarbonyl, ethoxycarbonyl, methoxycarbonyloxy, ethoxycarbonyloxy, methoxycarbonylmethyl, ethoxycarbonylmethyl, methoxycarbonyloxymethyl, ethoxycarbonyloxymethyl, methylthio, ethylthio, propylthio, methylthiomethyl, ethylthiomethyl, methylthioethyl, ethylthioethyl, methylamino, ethylamino, propylamino, isopropyl amino, dimethylamino, diethylamino, methylaminomethyl, ethylaminomethyl, dimethylaminomethyl, diethylaminoethyl, formylamino, acetylamino, formylaminomethyl, formylaminoethyl, methylsulfonylamino, ethylsulfonylamino, dimethylsulfonylamino, diethylsulfonylamino, methylsulfonylaminomethyl, ethylsulfonylaminomethyl, dimethylsulfonylaminomethyl, diethylsulfonylaminomethyl, phenyl, phenoxy, phenylcarbonyl, phenoxycarbonyl, phenylcarbonyloxy, phenoxymethyl, phenoxyethyl, phenylcarbonylmethyl, phenylcarbonylethyl, phenylmethyl (benzyl), phenylethyl (phenethyl) or one of the 11 last-mentioned radicals which is substituted in the phenyl moiety by one or more radicals selected from the group consisting of halogen, (C₁-C₄)alkyl, (C₁-C₄)alkoxy, (C₁-C₄)haloalkyl, (C₁-C₄)-haloalkoxy and hydroxyl.

Particular preference is given to herbicide combinations according to the invention comprising compounds of the formula (Ia) and salts thereof,

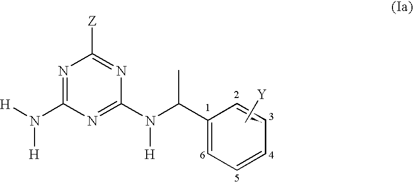

In which

Z is (C₁-C₄)alkyl or (C₁-C₄)haloalkyl,

Y is halogen, preferably fluorine or chlorine, methyl, ethyl, methoxy, ethoxy or CF₃ and

where the compounds of the formula (I) are optically active and are not present as racemic compound.

Preference is given to the compounds of the formulae (Ib), (Ic) and (Id) from Tables 1 to 3 below and salts thereof (note: the numbers at the phenyl ring in the formula (Ia) denote the numbers of the substituent position for the radicals of the radicals X different from hydrogen):

TABLE 1
Compounds of the formula (Ib)

| | |
|---|---|
| | (Ib) |
| 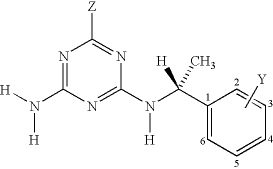 | |

The compounds correspond to the formula (Ia) with the S configuration at
the benzylic carbon atom

| No. | Z | Y |
|---|---|---|
| (A1) | CHFCH₃ | 4-CH₃ |
| (A2) | CF(CH₃)₂ | 4-CH₃ |
| (A3) | CH(CH₃)₂ | 4-CH₃ |
| (A4) | CH₂CH₃ | 4-CH₃ |
| (A5) | CHFCH₂CH₃ | 4-CH₃ |
| (A6) | CHFCH₃ | 3-CH₃ |
| (A7) | CF(CH₃)₂ | 3-CH₃ |
| (A8) | CH(CH₃)₂ | 3-CH₃ |
| (A9) | CH₂CH₃ | 3-CH₃ |
| (A10) | CHFCH₂CH₃ | 3-CH₃ |
| (A11) | CHFCH₃ | 2-F |
| (A12) | CF(CH₃)₂ | 2-F |
| (A13) | CH(CH₃)₂ | 2-F |
| (A14) | CH₂CH₃ | 2-F |
| (A15) | CHFCH₂CH₃ | 2-F |
| (A16) | CHFCH₃ | 3-F |
| (A17) | CF(CH₃)₂ | 3-F |
| (A18) | CH(CH₃)₂ | 3-F |
| (A19) | CH₂CH₃ | 3-F |
| (A20) | CHFCH₂CH₃ | 3-F |
| (A21) | CHFCH₃ | 4-F |
| (A22) | CF(CH₃)₂ | 4-F |
| (A23) | CH(CH₃)₂ | 4-F |
| (A24) | CH₂CH₃ | 4-F |
| (A25) | CHFCH₂CH₃ | 4-F |
| (A26) | CHFCH₃ | 3-Cl |
| (A27) | CF(CH₃)₂ | 3-Cl |
| (A28) | CH(CH₃)₂ | 3-Cl |
| (A29) | CH₂CH₃ | 3-Cl |
| (A30) | CHFCH₂CH₃ | 3-Cl |
| (A31) | CHFCH₃ | 4-Cl |
| (A32) | CF(CH₃)₂ | 4-Cl |
| (A33) | CH(CH₃)₂ | 4-Cl |
| (A34) | CH₂CH₃ | 4-Cl |
| (A35) | CHFCH₂CH₃ | 4-Cl |

TABLE 2
Compounds of the formula (Ic)

| | |
|---|---|
| | (Ic) |
| 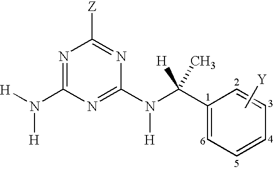 | |

The compounds corresond to the formula (Ia) with the R configuration at
the benzylic carbon atom

| No. | Z | Y |
|---|---|---|
| (A36) | CHFCH₃ | 4-CH₃ |
| (A37) | CF(CH₃)₂ | 4-CH₃ |
| (A38) | CH(CH₃)₂ | 4-CH₃ |
| (A39) | CH₂CH₃ | 4-CH₃ |
| (A40) | CHFCH₂CH₃ | 4-CH₃ |
| (A41) | CHFCH₃ | 3-CH₃ |
| (A42) | CF(CH₃)₂ | 3-CH₃ |
| (A43) | CH(CH₃)₂ | 3-CH₃ |
| (A44) | CH₂CH₃ | 3-CH₃ |
| (A45) | CHFCH₂CH₃ | 3-CH₃ |
| (A46) | CHFCH₃ | 2-F |
| (A47) | CF(CH₃)₂ | 2-F |
| (A48) | CH(CH₃)₂ | 2-F |
| (A49) | CH₂CH₃ | 2-F |
| (A50) | CHFCH₂CH₃ | 2-F |
| (A51) | CHFCH₃ | 3-F |
| (A52) | CF(CH₃)₂ | 3-F |
| (A53) | CH(CH₃)₂ | 3-F |
| (A54) | CH₂CH₃ | 3-F |
| (A55) | CHFCH₂CH₃ | 3-F |
| (A56) | CHFCH₃ | 4-F |
| (A57) | CF(CH₃)₂ | 4-F |
| (A58) | CH(CH₃)₂ | 4-F |
| (A59) | CH₂CH₃ | 4-F |
| (A61) | CHFCH₂CH₃ | 4-F |
| (A62) | CHFCH₃ | 3-Cl |
| (A63) | CF(CH₃)₂ | 3-Cl |
| (A64) | CH(CH₃)₂ | 3-Cl |
| (A65) | CH₂CH₃ | 3-Cl |
| (A66) | CHFCH₂CH₃ | 3-Cl |
| (A67) | CHFCH₃ | 4-Cl |
| (A68) | CF(CH₃)₂ | 4-Cl |
| (A69) | CH(CH₃)₂ | 4-Cl |
| (A70) | CH₂CH₃ | 4-Cl |
| (A71) | CHFCH₂CH₃ | 4-Cl |

TABLE 3
Compounds of the formula (Id)

| | |
|---|---|
| | (Id) |
| 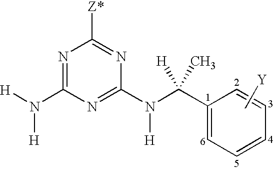 | |

The compounds correspond to the formula (Ia) with the RS configuration
at the benzylic carbon atom and a chiral radical Z = Z*.

| No. | Z* | Y |
|---|---|---|
| (A72) | (1R)—CHFCH₃ | 4-CH₃ |
| (A73) | (1S)—CHFCH₃ | 4-CH₃ |
| (A74) | (1R)—CHFCH₂CH₃ | 4-CH₃ |
| (A75) | (1S)—CHFCH₂CH₃ | 4-CH₃ |
| (A76) | (1R)—CHFCH₃ | 3-CH₃ |
| (A77) | (1S)—CHFCH₃ | 3-CH₃ |
| (A78) | (1R)—CHFCH₂CH₃ | 3-CH₃ |
| (A79) | (1S)—CHFCH₂CH₃ | 3-CH₃ |
| (A80) | (1R)—CHFCH₃ | 2-F |
| (A81) | (1S)—CHFCH₃ | 2-F |
| (A82) | (1R)—CHFCH₂CH₃ | 2-F |
| (A83) | (1S)—CHFCH₂CH₃ | 2-F |
| (A84) | (1R)—CHFCH₃ | 3-F |
| (A85) | (1S)—CHFCH₃ | 3-F |
| (A86) | (1R)—CHFCH₂CH₃ | 3-F |
| (A87) | (1S)—CHFCH₂CH₃ | 3-F |
| (A88) | (1R)—CHFCH₃ | 4-F |
| (A89) | (1S)—CHFCH₃ | 4-F |
| (A90) | (1R)—CHFCH₂CH₃ | 4-F |
| (A91) | (1S)—CHFCH₂CH₃ | 4-F |
| (A92) | (1R)—CHFCH₃ | 3-Cl |
| (A93) | (1S)—CHFCH₃ | 3-Cl |
| (A94) | (1R)—CHFCH₂CH₃ | 3-Cl |
| (A95) | (1S)—CHFCH₂CH₃ | 3-Cl |
| (A96) | (1R)—CHFCH₃ | 4-Cl |
| (A97) | (1S)—CHFCH₃ | 4-Cl |
| (A98) | (1R)—CHFCH₂CH₃ | 4-Cl |
| (A99) | (1S)—CHFCH₂CH₃ | 4-Cl |

Some optically active aminotriazines of the formula (I) and salts thereof (hereinbelow together also referred to in short as “compounds (I) according to the invention” or “compounds (I)”) are already known from the literature mentioned above, specifically optically active compounds for example from DE-A-19810349. The international application No. PCT/EP00/11861 (WO-A-01/44208) also proposes optically active compounds (I). The compounds (I) can be prepared by the methods described therein or similarly known methods, as described in the patent publications also mentioned further above, and in the literature cited therein.

For preferred compounds, their preparation and general conditions for their use and in particular for specific example compounds, reference is made to the descriptions of the publications mentioned, and these descriptions are inasmuch part of the present invention.

The compounds (I) can be obtained, for example, from optically active biguanidines by reaction of optically active amines and cyanoguanidine of the formula H₂N—C(═NH)—NH—CN (see, for example, EP-A492615). In general, the reaction can be carried out efficiently under acid catalysis and in the presence of an organic solvent, such as an optionally halogenated hydrocarbon. Here, suitable catalysts are, for example, mineral acids, such as hydrogen chloride; suitable solvents are, for example, dichloromethane or n-decane. The reaction is carried out, for example, in the range from 0 to 200° C., preferably from 90 to 180° C.

The optically active amines required for the above reaction and the preparation variant b) are known or can be prepared by processes known per se (cf. Tetrahedron Lett. 29 (1988) 223-224, Tetrahedron Lett. 36 (1995) 3917-3920; Tetrahedron, Asymmetry 5 (1994) 817-820; EP-A-320898, EP-A-443606, DE-A-3426919, DE-A-4000610).

Optically active compounds can also be obtained by customary methods of optical resolution (cf. Handbooks of Stereochemistry), mixtures of enantiomers that remain, for example, after processes for separating mixtures into diastereomers have been carried out, for example physical processes such as crystallization, chromatographic processes, especially column chromatography and high pressure liquid chromatography, distillation, if appropriate under reduced pressure, extraction and other processes, can generally be separated by chromatographic separation on chiral solid phases. Processes suitable for preparative amounts or use on an industrial scale are processes such as crystallization of diastereomeric salts which can be obtained from the compounds (I) and optically active acids and, if acidic groups are present, optically active bases.

Suitable optically active acids for optical resolutions by crystallization of diastereomeric salts are, for example, camphorsulfonic acid, camphoric acid, bromocamphorsulfonic acid, quinic acid, tartaric acid, dibenzoyltartaric acid and other analogous acids; suitable optically active bases are, for example, quinine, cinchonidine, quinidine, brucine, 1-phenylethylamine and other analogous bases.

The crystallizations are then in most cases carried out in aqueous or aqueous-organic solvents, where the diastereomer having the lower solubility precipitates first, if appropriate after seeding. One enantiomer of the compound of the formula (I) is then liberated from the precipitated salt or the other from the filtrate by acidification or using a base.

The active compounds (A) are suitable for controlling weeds in a number of plant crops, for example in crops of economical importance, such as cereals (wheat, barley, rye, rice, corn), sugar beet, sugar cane, oilseed rape, cotton and soy. Of particular interest is the use in cereals such as wheat and corn, in particular corn. These crops are also preferred for the combinations (A)+(B).

Suitable combination partners (B) are, for example, one or more of the following compounds of subgroups (B1) to (B4) (in most cases, the herbicides are referred to by the common name, in accordance with the reference “The Pesticide Manual” 12th Ed., British Crop Protection Council 2000, abbreviated “PM”.

(B1) foliar- and/or soil-acting herbicides which are active against monocotyledonous harmful plants, preferably

(B1.1) ureas which are predominantly soil-acting, such as

(B1.1.1) isoproturon (PM, pp. 559-560), i.e. 3-(4-isopropylphenyl)-1,1-dimethylurea and/or

(B1.1.2) chlorotoluron (PM, pp. 142-169), i.e. 3-(3-chloro-p-tolyl)-1,1-dimethylurea and/or

(B1.2) compounds of various structures, which are predominantly soil-acting, such as

(B1.2.1) flufenacet (=fluthiamide, see PM, pp. 434-435), i.e. 4′-fluoro-N-isopropyl-2-(5-trifluoromethyl-1,3,4-thiadiazol-2-yloxy)acetanilide and/or

(B1.2.2) pendimethalin (PM, pp. 714-715), i.e. N-(1-ethylpropyl)-2,6-dinitro-3,4-xylidine and/or

(B1.2.3) prosulfocarb (PM, pp. 786-787), i.e. s-benzyl dipropylthiocarbamate and/or

(B1.3) 2-(4-heteroaryl- or 4-aryloxyphenoxy)propionic acids which are predominantly foliar-acting, such as

(B1.3.1) clodinafop-propargyl (PM, pp. 186-187), i.e. prop-2-ynyl (R)-2-[4-[(5-chloro-3-fluoro-2-pyridinyl)oxy]phenoxy]propanoate and/or

(B1.3.2) diclofop-methyl (PM, pp. 279-280), i.e. methyl (RS)-2-[4-(2,4-dichlorophenoxy)phenoxy]propanoate and/or

(B1.3.3) fenoxaprop-P-ethyl (PM, pp. 393-394), i.e. ethyl (R)-2-[4-[(6-chloro-2-benzoxazolyl)oxy]phenoxy]propanoate, also in the form of the mixtures of the optical isomers, for example the racemic mixture fenoxaprop-ethyl (B1.3.3-RS) and/or

(B1.3.4) quizalofop-P and its esters, such as the ethyl or tefuryl ester (PM, pp. 822-824), also in the form of the mixtures of the optical isomers, for example the racemic mixture quizalofop and its esters and/or

(B1.3.5) fluazifop-P and its esters, such as the butyl ester (PM, pp. 423-424), also in the form of the mixtures of the optical isomers, for example the racemic mixture fluazifop-butyl (B1.3.5-RS) and/or

(B1.3.6) haloxyfop and haloxyfop-P(R1.3.6-R) and their esters, such as the methyl or the etotyl ester (PM, pp. 499-501) and/or

(B1.3.7) propaquizafop (PM, pp. 773-774) and/or

(B1.3.8) cyhalofop and its esters, such as the butyl ester (PM, pp. 223-224) (=(R)-2-[4-(4-cyano-2-fluorophenoxy)phenoxy]propionic acid or butyl (R)-2-[4-(4-cyano-2-fluorophenoxy)phenoxy]propionate) and/or

(B1.4) cyclohexanedione oximes which are predominantly foliar-acting, such as

(B1.4.1) sethoxydim (PM, pp. 832-833), i.e. (E,Z)-2-(1-ethoxyiminobutyl)-5-[2-(ethylthio)propyl]-3-hydroxycyclohex-2-enone, and/or

(B1.4.2) cycloxydim (PM, pp. 218-219), i.e. 2-(1-ethoxyiminobutyl)-3-hydroxy-5-thian-3-ylcyclohex-2-enone, and/or

(B1.4.3) clethodim (PM, pp.185-186), i.e. 2-{(E)-1-[(E)-3-chloroallyloxy-imino]propyl}-5[-2-(ethylthio)propyl]-3-hydroxycyclohex-2-enone and/or

(B1.4.4) profoxydim or “BAS 625H” (=clefoxidim) (see PM, pp. 61-62), i.e. 2-[1-2-(4-chlorophenoxy)propoxyimino)butyl]-3-oxo-5-thion-3-ylcyclohex-1-enol,

(B1.4.5) tralkoxydim (PM, pp. 914-915), i.e. 2-[1-(ethoxyimino)propyl]-3-hydroxy-5-mesitylcyclohex-2-enone, and/or

(B1.5) chloroacetamides which are predominantly soil acting, such as

(B1.5.1) dimethenamid (PM, pp. 305-306), i.e. 2-chloro-N-(2,4-dimethyl-3-thienyl)-N-(2-methoxy-1-methylethyl)acetamide, and/or

(B1.5.2) penthoxamid, i.e. 2-chloro-N-(2-ethoxyethyl)-N-(2-methyl-1-phenyl-1-propenyl)acetamide (TKC-94, known from AG Chem New Compound, Review Vol.17 (1999), EP-A-206 251), and/or

(B1.5.3) butachlor (PM, pp.117-118), i.e. N-(butoxymethyl)-2-chloro-N-(2,6-diethylphenyl)acetamide, and/or

(B1.5.4) pretilachlor (PM, pp. 755-756), i.e. 2-chloro-N-(2,6-diethylphenyl)-N-(propoxyethyl)acetamide, and/or

(B1.6) compounds having various structures and foliar and/or soil action, such as

(B1.6.1) imazamethabenz-methyl (PM, pp. 526-527), i.e. methyl (±)-2-(4-isopropyl-4-methyl-5-oxo-2-imidazolin-2-yl)para- and -meta-toluate, and/or

(B1.6.2) simazin (PM, pp. 836-837), i.e. 6-chloro-N,N′-diethyl-2,4-diamino-1,3,5-triazine, and/or

(B1.6.3) molinate (PM, pp. 652-653), i.e. S-ethyl azepane-1-thiocarboxylate, and/or

(B1.6.4) thiobencarb (benthiocarb) (PM, pp. 901-902), i.e. S-4-chlorobenzyl diethylthiocarbamate, and/or

(B1.6.5) oxaziclomefone (MY 100) (pp. 696) i.e. 3-[1-(3,5-dichlorophenyl)-1-methylethyl]-3,4-dihydro-6-methyl-5-phenyl-2H-1,3-oxazin-4-one, and/or

(B1.6.6) anilofos (PM, pp. 38), i.e. S4-chloro-N-isopropylcarbaniloylmethyl 0,0-dimethyl dithiophosphate, and/or

(B1.6.7) cafenstrole (CH 900) (PM, pp. 128-129), i.e. N,N-diethyl-3-mesitylsulfonyl-1H-1,2,4-triazole-1-carboxamide, and/or

(B1.6.8) mefenacet (PM, pp. 593-594), i.e. 2-(1,3-benzothiazol-2-yloxy)-N-methylacetanilide, and/or

(B1.6.9) fentrazamid (NBA 061), (PM, pp. 406-407), i.e. N-cyclohexyl-N-ethyl-4-(2-chlorophenyl)-5-oxo-4,5-dihydrotetrazole-1-carboxamide, and/or

(B1.6.10) thiazopyr (PM, pp. 897-898), i.e. methyl 2-difluoromethyl-5-(4,5-dihydro-1,3-thiazol-2-yl)-4-isobutyl-6-trifluoromethylnicotinate, and/or

(B1.6.11) oxadiazon (PM. pp. 691-692), i.e. 3-tert-butyl-3-(2,4-dichloro-5-isopropoxyphenyl)-1,3,4-oxadiazol-2 (3H)one, and/or

(B1.6.12) esprocarb (PM, pp. 354-355), i.e. S-benzyl 1,2-dimethylpropyl-(ethyl)thiocarbamate, and/or

(B1.6.13) pyributicarb (PM, pp. 802), i.e. 0-3-tert-butylphenyl 6-(methoxy-2-pyridyl(methyl)thiocarbamate, and/or

(B1.6.14) azimsulfuron (PM, pp.48-50), i.e. 1-(4,6-dimethoxypyrimidin-2-yl)-3-[1-methyl-4-(2-methyl-2H-tetrazol-5-yl)pyrazol-5-ylsulfonyl]urea, and/or

(B1.6.15) thenylchlor (PM, pp. 893-894), i.e. 2-chloro-N-(2,6-dimethylphenyl)-N-[(3-methoxy-2-thienyl)methyl]acetamide, and/or

(B1.6.16) pentoxazone (KPP 314) (PM, pp. 718-719), i.e. 3-(4-chloro-5-cyclopentyloxy-2-fluorophenyl)-5-isopropylidene-1,3-oxazolidine-2,4-dione, and/or

(B1.6.17) pyriminobac, pyriminobac-methyl (KIH 6127) (PM, pp. 810-811), i.e. 2-(4,6-dimethoxy-2-pyrimidinyloxy)-6-(1-methoxyiminoethyl)benzoic acid), and its salts and esters, such as the methyl ester, and/or

(B1.6.18) flucarbazone and its salts, such as flucarbazone sodium salt (BAY MKH 6562) (PM, pp. 427-425), i.e. 1H-1,2,4-triazole-1-carboxamide-4,5-dihydro-3-methoxy-4-methyl-5-oxo-N-[[2-(trifluoromethoxy)phenyl]sulfonyl] sodium salt, preferably in amounts of 5-100, in particular 10-80, g of a.s./ha, and/or

(B1.6.19) procarbazone (BAY MKH 6561, known from AG Chem New Compound, Review Vol.17 (1999), page 27 and EP-A-507171), i.e. methyl 2-[[[(4,5-dihydro-4-methyl-5-oxo-3-propoxy-1H-1,2,4-triazol-1-yl)carbonyl]amino]sulfonyl]benzoate, and its salts, preferably in amounts of 10-150, in particular 50-120, g of a.s./ha and/or (B2) herbicides which are predominantly active against dicotyledonous plants, preferably

(B2.1) sulfonylureas, such as

(B2.1.1) tribenuron-methyl (PM, pp.928-929), i.e. methyl 2-[4-methoxy-6-methyl-1,3,5-triazin-2-yl(methyl)carbamoylsulfamoyl]benzoate, and/or

(B2.1.2) thifensulfuron and its esters, preferably the methyl ester (PM, pp. 899-900), i.e. 3-[[[(4-methoxy-6-methyl-1,3,5-triazin-2-yl)amino]carbonyl]amino]sulfonyl]-2-thiophenecarboxylic acid or methyl 3-[[[(4-methoxy-6-methyl-1,3,5-triazin-2-yl)amino]-carbonyl]amino]sulfonyl]-2-thiophenecarboxylate and its salts, and/or

(B2.1.3) prosulfuron (PM, pp. 787-788), i.e. 1-(4-methoxy-6-methyl-1,3,5-triazin-2-yl)-3-[2-(3,3,3-trifluoropropyl)phenylsulfonyl]urea and its salts, and/or

(B2.1.4) amidosulfuron (PM, pp. 29-30), i.e. 1-(4,6-dimethoxypyrimidin-2-yl)-3-mesyl(methyl)sulfamoylurea and its salts, and/or

(B2.1.5) chlorimuron and its esters, such as chlorimuron-ethyl (PM, pp.161-162) (=2-(4-chloro-2-methoxypyrimidin-2-ylcarbamoylsulfamoyl)benzoic acid and its esters, such as the ethyl ester) and/or

(B2.1.6) halosulfuron and its esters, such as the methyl ester (PM, pp. 497-499), i.e. methyl 3-chloro-5-(4,6-dimethoxypyrimidin-2-ylcarbamoylsulfamoyl)-1-methylpyrazolecarboxylate, also in its salt form, and/or

(B2.1.7) LAB271272, (=tritosulfuron, CAS Reg. No. 142469-14-5; see AG Chem New Compound Review, Vol. 17,1999, pp. 24, published by AGRANOVA), i.e. N-[[[4-methoxy-6-(trifluoromethyl)-1,3,5-triazin-2-yl)amino]carbonyl]-2-(trifluoromethyl)benzenesulfonamide), preferably in an amount of 2-250, in particular 10-150, g of a.s./ha, and/or

(B2.1.8) bensulfuron-methyl (PM, pp. 76-77), i.e. methyl 2-[[[[[(4,6-dimethoxy-2-pyrimidinyl)amino]carbonyl]amino]sulfonyl]methyl]benzoate, and/or

(B2.1.9) ethoxysulfuron (PM, pp. 367-368), i.e. 1-(4,6-dimethoxypyrimidin-2-yl) -3-(2-ethoxyphenoxysulfonyl)urea, and/or

(B2.1.10) cinosulfuron (PM, pp. 183-184), i.e. 1-(4,6-dimethoxy-1,3,5-triazin-2-yl)-3-[2-(2-methoxyethoxy)phenylsulfonyl)urea, and/or

(B2.1.11) pyrazosulfuron and its esters, such as pyrazosulfuron-ethyl (PM, pp.1795-797) (=5-(4,6-dimethoxypyrimidin-2-ylcarbamoylsulfamoyl)-1-methylpyrazole-4-carboxylic acid and its salts and esters, such as the ethyl ester), and/or

(B2.1.12) imazosulfuron (PM, pp. 534-535), i.e. 1-(2-chloroimidazo[1,2-a]pyridin-3-yisulfonyl)-3-(4,6-dimethoxypyrimidin-2-yl)urea, and/or

(B2.1.13) cyclosulfamuron (PM, pp. 217-218), i.e. 1-(2-(cyclopropylcarbonyl)phenylsulfamoyl]-3-(4,6-dimethoxypyrimidin-2-yl)urea, and/or

(B2.2) growth regulators (of the auxin type), such as

(B2.2.1) MCPA (PM, pp. 583-584), i.e. (4-chloro-2-methylphenoxy)acetic acid and its salts and esters, and/or

(B2.2.2) 2,4-D (PM, pp. 243-246), i.e. 2,4-dichlorophenoxyacetic acid and its salts and esters, and/or

(B2.2.3) dichlorprop-P (PM, pp. 275-276), i.e. (R)-2-(2,4-dichlorophenoxy)-propionic acid, also in the racemic form dichlorprop (PM, pp. 273-275)

(B2.2.3-RS), and the salts and esters, and/or

(B2.2.4) mecoprop-P (PM, pp. 591-592), i.e. (R)-2-(4-chloro-o-tolyloxy)propionic acid, also in the racemic form mecoprop (PM, pp. 590-591) (B2.2.4-RS), and their respective salts and esters, and/or

(B2.2.5) fluoroxypyr (PM, pp.455-457), i.e. 4-amino-3,5-dichloro-6-fluoro-2-pyridyloxyacetic acid, and its salts and esters, and/or

(B2.2.6) dicamba (PM, pp. 265-267), i.e. 3,6-dichloro-o-anisic acid and its salts and esters, and/or

(B2.2.7) clopyralid (PM, pp.193-194), i.e. 3,6-dichloro-2-pyridinecarboxylic acid, and its salts and esters, preferably in an amount of 10-2000, in particular 20-1000 g a.s./ha and/or

(B2.2.8) picloram (PM, pp. 740-742), i.e. 4-amino-3,5,6-trichloropicolinic acid and its salts and esters, and/or

(B2.3) hydroxybenzonitriles, such as

(B.2.3.1) bromoxynil (PM, pp.110-112), i.e. 3,5-dibromo-4-hydroxybenzonitrile and its salts and esters, and/or

(B.2.3.2) ioxynil (PM, pp. 548-550), i.e. 4-hydroxy-3,5-diiodobenzonitrile and its salts and esters, and/or

(B2.4) diphenyl ethers, such as

(B2.4.1) fluoroglycofen-ethyl (PM, pp.444-445), i.e. ethyl O-[5-(2-chloro-α,α,α-trifluoro-p-tolyloxy)-2-nitrobenzoyl]glycolate, and/or

(B2.4.2) aclonifen (PM, pp. 14-15), i.e. 2-chloro-6-nitro-3-phenoxyaniline, preferably in an amount of 10-5000, in particular 20-3000, g of a.s./ha, and/or

(B2.4.3) acifluorfen (PM, pp.12-14) and its salts, such as the sodium salt (=5-[2-chloro-4-(trifluoromethyl)phenoxy]-2-nitrobenzoic acid and its salts, such as the Na salt), and/or

(B2.5) [1,2,4]triazolopyrimidinesulfonamides, such as

(B2.5.1) cloransulam and preferably the methyl ester (PM, pp.196-197), i.e. 3-chloro-2-(5-ethoxy-7-fluoro[1,2,4]triazolo[1,5-c]pyrimidin-2-ylsulfonamido)benzoic acid or methyl 3-chloro-2-(5-ethoxy-7-fluoro-[1,2,4]triazolo[1,5-c]pyrimid in-2-ylsulfonamido)benzoate, and/or

(B2.5.2) florasulam, i.e. N-(2,6-difluorophenyl)-8-fluoro-5-methoxy-1,2,4-triazolo[1,5c]pyrimidine-2-sulfonamide (PM, pp. 420-421), and/or

(B2.6) compounds of various structures, such as

(B2.6.1) bentazone (PM, pp. 80-81), i.e. 3-isopropyl-1H-2,1,3-benzothiadiazin-4 (3H)one 2,2-dioxide, and/or

(B2.6.2) bifenox (PM, pp. 87-88), i.e. methyl 5-(2,4-dichlorophenoxy)-2-nitrobenzoate, and/or

(B2.6.3) carfentrazone-ethyl (PM, pp.141-142), i.e. ethyl (RS)-2-chloro-3-[2-chloro-4-(4-difluoromethyl-4,5-dihydro-3-methyl-5-oxo-1H-1,2,4-triazol-1-yl)-4-fluorophenyl]propionate, and/or

(B2.6.4) pyraflufen (PM, pp.792-793), i.e. 2-chloro-5-(4-chloro-5-difluoromethoxy-1-methylpyrazol-3-yl)-4-fluorophenoxyacetic acid, and/or

(B2.6.5) pyridate (PM, pp. 805-806), i.e. O-(6-chloro-3-phenylpyridazin-4-yl) S-(octyl) thioformate, and/or

(B2.6.6) linuron (PM, pp. 572-573), i.e. 3-(3,4-dichlorophenyl)-1-methoxy-1-methylurea, and/or

(B2.6.7) diflufenzopyr (BASF 654 00H) (PM, pp.297-298), i.e. 2-{1-[4-(3,5-difluorophenyl)semicarbazone]ethyl}nicotinic acid, and its salts,

(B2.6.8) cinidon-ethyl (PM, pp.181-182), i.e. ethyl (2)-2-chloro-3-[2-chloro-5-(1,2-cyclohex-1-enedicarboximido)phenyl]acrylate, preferably in an amount of 5-500, in particular 10-400, g of a.s./ha, and/or

(B2.6.9) metribuzin (PM, pp.642-644), preferably in an amount of 50-3000, in particular 60-2000, g of a.s./ha, and/or

(B2.6.10) picolinafen (PM, pp.742-743), i.e. N-4-fluorophenyl-6-(3-trifluoromethylphenoxy)pyridine-2-carboxamide (AC 900001), preferably in an amount of 1-90, in particular 2-80, g of a.s./ha, and/or

(B2.6.11) clomazone (PM, pp.190-191), preferably in an amount of 50-5000, in particular 100-3000, g of a.s./ha, and/or

(B2.6.12) bromobutide (PM, pp.108), i.e. 2-bromo-3,3-dimethyl-N-(1-methyl-1-phenylethyl)butyramide, and/or

(B2.6.13) benfuresate (PM, pp. 71-72), i.e. 2,3-dihydro-3,3-dimethylbenzofuran-5-yl ethanesulfonate, and/or

(B2.6.14) dithiopyr (PM, pp. 330) (=S,S′-dimethyl 2-difluoromethyl-4-isobutyl-6-trifluoromethylpyridine-3,5-di(thiocarboxylate)), and/or

(B2.6.15) triclopyr (PM, pp. 933-934), i.e. 3,5,6-trichloro-2-pyridyloxyacetic acid, and its salts and esters, and/or

(B3) herbicides which are active against monocotyledonous and dicotyledonous harmful plants, preferably

(B3.1) sulfonylureas, such as

(B3.1.1) metsulfuron-methyl (PM, pp. 664-645), i.e. 2-[(4-methoxy-6-methyl-1,3,5-triazin-2-yl)carbamoylsulfamoyl]benzoic acid, and/or

(B3.1.2) triasulfuron (PM, pp. 922-923), i.e. 1-[2-(2-chloroethoxy)-phenylsulfonyl]-3-(4-methoxy-6-methyl-1,3,5-triazin-2-yl)urea, and/or

(B3.1.3) chlorsulfuron (PM, pp.175-176), i.e. 1-(2-chlorosulfonyl)-3-(4-methoxy-6-methyl-1,3,5-triazin-2-yl)urea, and/or

(B3.1.4) iodosulfuron-methyl and preferably its sodium salt (PM, pp. 547-548), i.e. methyl 4-iodo-2-(4-methoxy-6-methyl-1,3,5-triazin-2-ylcarbamoyl-sulfamoyl)benzoate or the corresponding sodium salt, and/or

(B3.1.5) mesosulfuron, i.e. methyl 4-methylsulfonylamino-2-(4,6-dimethoxy-pyrimidin-2-ylcarbamoylsulfamoyl)benzoate, known from WO-A-95/10507, and/or

(B3.1.6) sulfosulfuron (PM, pp. 853-854), i.e. 1-(4,6-dimethoxypyrimidin-2-yl)-3-(2-ethylsulfonylimidazole[1,2-a]pyridin-3-yl)sulfonylurea, and/or

(B3.1.7) flupyrsulfuron-methyl (PM, pp.447-448), i.e. 2-(4,6-dimethoxypyrimidin-2-ylcarbamoylsulfamoyl)-6-trifluoromethylnicotinic acid, preferably the sodium salt of the methyl ester, and/or

(B3.1.8) nicosulfuron (PM, pp. 672-673), i.e. 2-(4,6-dimethoxypyrimidin-2-yl)-3-(3-dimethylcarbamoyl-2-pyridylsulfonyl)urea, and/or

(B3.1.9) rimsulfuron (PM, pp. 826-827), i.e. 1-(4,6-dimethoxypyrimidin-2-yl)-3-(3-ethylsulfonyl-2-pyridylsulfonyl)urea, and/or

(B3.1.10) primisulfuron (PM, pp. 756-758), i.e. methyl 2-[4,6-bis(difluoromethoxy)pyrimidin-2-ylcarbamoylsulfamoyl]benzoate, and/or

(B3.1.11) foramsulfuron, i.e. 4-formylamino-2-[[(4,6-dimethoxypyrimidin-2-yl)-carbamoyl]sulfamoyl]-N,N-dimethylbenzamide, known from EP-A-0757679, and/or

(B3.2) triazine derivatives, such as

(B3.2.1) cyanazine (PM, pp. 211-212), i.e. 2-(4-chloro-6-ethylamino-1,3,5-triazin-2-ylamino)-2-methylpropionitrile, and/or

(B3.2.2) atrazin (PM, pp. 42-43), i.e. N-ethyl-N′-isopropyl-6-chloro-2,4-diamino-1,3,5-triazine, and/or

(B3.2.3) terbuthylazine (PM, pp. 881-882), i.e. N-ethyl-N′-tert-butyl-6-chloro-2,4-diamino-1,3,5-triazine, and/or

(B3.2.4) terbutryn (PM, pp. 883-884), i.e. N-(1,1-dimethylethyl)-N′-ethyl-6-methylthio-2,4-diamino-1,3,5-triazine, and/or

(B3.3) chloroacetamides, such as

(B3.3.1) acetochlor (PM, pp. 10-11), i.e. 2-chloro-N-(ethoxymethyl)-N-(2-ethyl-6-methylphenyl)acetamide, and/or

(B3.3.2) S-metolachlor (PM, pp. 637-638), i.e. (aRS, 1-R)-2-chloro-N-(2-ethyl-6-methylphenyl)-N-(2-methoxy-1-methylethyl)acetamide, also in the form of racemic metolachlor (B3.3.2-RS) (PM, pp. 635-636), and/or

(B3.3.3) alachlor (PM, pp.19-20), i.e. 2-chloro-N-(2,6-diethylphenyl)-N-(methoxymethyl)acetamide, and/or

(B3.4) compounds of various structures, such as

(B3.4.1) diflufenican (PM, pp. 397-399), i.e. 2′,4′-difluoro-2-(α,α,α-trifluoro-m-tolyloxy)nicotinanilide, and/or

(B3.4.2) flumetsulam (PM, pp. 573-574), i.e. 2′,6′-difluoro-5-methyl[1,2,4]triazolo[1,5-a]pyrimidine-2-sulfoanilide, and/or

(B3.4.3) flurtamone (PM, pp.602-603), i.e. (RS)-5-methylamino-2-phenyl-4-(α,α,α-trifluoro-m-tolyl)furan-3 (2H)one, and/or

(B3.4.4) isoxaflutole (PM, pp.737-739), i.e. 5-cyclopropyl-1,2-oxazol-4-yl α,α,α-trifluoro-2-mesyl-p-tolyl ketone, and/or

(B3.4.5) metosulam (PM, pp.640-641), i.e. 2′,6′-dichloro-5,7-dimethoxy-3′-methyl[1,2,4]triazole[1,5-a]pyrimidine-2-sulfoanilide, and/or

(B3.4.6) paraquat (salts), for example the dichloride (PM, pp. 705-706), i.e. 1,1′-(dimethyl)-4,4′-bipyridinium dichloride or other salts, and/or

(B3.4.7) benoxacor (PM, pp.74-75), i.e. 4-dichloroacetyl-3,4-dihydro-3-methyl-2H-1,4-benzoxazine, and/or

(B3.4.8) sulcotrione (PM, pp.848-849), i.e. 2-(2-chloro-4-mesyl-benzoyl)cyclohexane-1,3-dione, and/or

(B3.4.9) mesotrione (PM, p. 602), i.e. 2-(4-mesyl-2-nitrobenzoyl) cyclohexane-1,3-dione, and/or

(B3.4.10) quinclorac (PM, pp.815-816), i.e. 3,7-dichloroquinoline-8-carboxylic acid, and/or

(B3.4.11) propanil (PM, pp. 771-772), N-(3,4-dichlorophenyl)propanamide), and/or

(B3.4.12) bispyribac, bispyribac-Na (KIH 2023) (PM, pp. 97-98), i.e. sodium 2,6-bis(4,6-dimethoxy-2-pyrimidin-2-yloxy)benzoate salt, and/or

(B3.4.13) pyribenzoxim (LGC 40863) (PM, p. 801), i.e. 2,6-bis(4,6-dimethoxypyridin-2-yl)-1-[N-(diphenylmethyl)iminooxycarbonyl]benzene, and/or

(B3.4.14) oxadiargyl (PM, pp.690-691), i.e. 5-tert-butyl-3-[2,4-dichloro-5-(prop-2-ynyloxy)phenyl]-1,3,4-oxadiazol-2 (3H)one, and/or

(B3.4.15) norflurazon (PM, pp.678-679), i.e. 4-chloro-5-(methylamino)-2-[3-(trifluoromethyl)phenyl]-3-(2H)pyridazinone, and/or

(B3.4.16) fluometuron (PM, pp.442-443), i.e. N,N-dimethyl-N′-[3-trifluoromethyl)phenyl]urea; and/or

(B3.4.17) methylarsonic acid of the formula CH₃AS(═O)(OH)₂ and its salts, such as DSMA=disodium salt or MSMA=monosodium salt of methylarsonic acid (PM, pp.625-626), and/or

(B3.4.18) prometryn (promethyrin) (PM, pp. 766-767), i.e. N,N′-bis(1-methylethyl)-6-methylthio)-2,4-diamino-1,3,5-triazine, and/or

(B3.4.19) trifluralin (PM, pp. 942-943), i.e. 2,6-dinitro-N,N-dipropyl-4-trifluoromethylaniline, and/or

(B4) herbicides which are active against monocotyledonous and dicotyledonous harmful plants and which can be employed specifically in tolerant crops and on non-crop land, preferably (B4.1) compounds of the glufosinate or phosphinothricin (═L-glufosinate) type and their salts and derivatives, such as

(B4.1.1) glufosinate in a narrow sense (PM, pp. 486-487), i.e. D,L-2-amino-4-[hydroxy(methyl)phosphinyl]butanoic acid or its active L-enantiomer and its salts, preferably the racemic glufosinate-monoammonium salt,

(B4.1.2) bilanafos (or bialaphos) (PM, pp. 90-91), i.e. L-2-amino-4-[hydroxy(methyl)phosphinyi]butanoyl-L-alanyl-L-alanine, in particular its sodium salt.

(B4.2) compounds of the type of the phosphonomethylglycine and its salts, such as

(B4.2.1) glyphosate (PM, pp. 488-491), i.e. N-(phosphonomethyl)glycine or its salts, preferably the glyphosate-monoisopropyl ammonium salt or the corresponding sodium salt, and/or

(B4.2.2) sulfosate, i.e. N-(phosphonomethyl)glycine trimesium salt=N-(phosphonomethyl)glycine trimethylsulfoxonium salt (PM, pp. 488491), and/or

(B4.3) imidazolinones, such as

(B4.3.1) imazapyr (PM, pp. 530-531) and its salts and esters, and/or

(B4.3.2) imazethapyr (PM, pp. 533-534) and its salts and esters, and/or

(B4.3.3) imazamethabenz (PM, pp. 526-527) and its salts and esters such as the methyl ester, and/or

(B4.3.4) imazamox (PM, pp. 528) and its salts and esters, and/or

(B4.3.5) imazaquin (PM, pp. 531-533) and its salts and esters, for example the ammonium salt, and/or

(B4.3.6) imazapic (AC 263,222) (PM, p. 529) and its salts and esters, for example the ammonium salt, and/or

(B4.4) compounds of various structural types, such as

(B4.4.1) WC9717 or CGA276854=1-allyloxycarbonyl-1-methylethyl 2-chloro-5-(3-methyl-2,6-dioxo-4-trifluoromethyl-3,6-dihydro-2H-pyrimidin-1-yl)benzoate (known from U.S. Pat. No. 5,183,492)

(B4.4.2) azafenidin (PM, pp. 46-47), i.e. 2-(2-dichloro-5-prop-2-ynyloxyphenyl)-5,6,7,8-tetrahydro-1,2,4-triazolo[4,3-a]pyridin-3(2Hone, and/or

(B4.4.3) diuron (PM, pp. 331-332), i.e. 3-(3,4-dichlorophenyl)-1,1-dimethylurea, and/or

(B4.4.4) oxyfluorfen (PM, pp. 702-703), i.e. 2-chloro-1-(3-ethoxy-4-nitrophenoxy)-4-(trifluoromethyl)benzene.

When the short form of the common name is used, this includes all customary derivatives, such as esters and salts, in particular the commercially available form or forms. In the case of sulfonylureas, salts include those which are formed by exchanging a hydrogen atom at the sulfonamide group for a cation.

Preference is given to herbicide combinations of one or more compounds (A) with one or more compounds of group (B1) or (B2) or (B3) or (B4).

Preference is furthermore given to combinations of compounds (A) with one or more compounds (B) according to the scheme:

(A)+(B1)+(B2), (A)+(B1)+(B3), (A)+(B1)+(B4) or (A)+(B2)+(B3), (A)+(B2)+(B4), (A)+(B3)+(B4) or (A)+(B1)+(B2)+(B3), (A)+(B1)+(B2)+(B4), (A)+(B4)+(B2)+(B3), (A)+(B1)+(B3)+(B4) or (A)+(B1)+(B2)+(B3)+(B4).

Also according to the invention are combinations in which one or more further active compounds of a different structure [active compounds (C)] are added, such as

(A)+(B1)+(C), (A)+(B2)+(C) or (A)+(B3)+(C), (A)+(B4)+(C), (A)+(B1)+(B2)+(C),(A)+(B1)+(B3)+(C), (A)+(B1)+(B4)+(C)or (A)+(B2)+(B3)+(C), (A)+(B2)+(B4)+(C), (A)+(B3)+(B4)+(C) or (A)+(B1)+(B2)+(B3)+(C), (A)+(B1)+(B2)+(B4)+(C), (A)+(B4)+(B2)+(B3) +(C), (A)+(B1)+(B3)+(B4)+(C) or (A)+(B1)+(B2)+(B3)+(B4)+(C).

For combinations of the last-mentioned kind with three or more active compounds, the preferred conditions explained below in particular for two-compound combinations according to the invention primarily apply likewise if they comprise the two-compound combinations according to the invention.

The application rate of the herbicides (A) can be varied within wide limits; the optimum rate depends on the herbicide in question, on the spectrum of harmful plants and on the crop plants. In general, the application rate is in the range from 10 to 1200, preferably 15 to 800, very particularly preferably from 10 to 150 g, of active compound (a.s.)/ha.

The application rates of the herbicides (B) can vary considerably from herbicide to herbicide. As a rule of thumb, for preferred application rates, the following details can apply, it also being possible in the combinations according to the invention for amounts below the lowest amount to be useful (a.s.=active substance).

Compounds of groups (B1.1) and (B1.2): 0.5 to 5000, in particular 50-5000, g of a.s./ha, predominantly against weed grasses by the post-emergence method, but also by the pre-emergence method;

compounds of groups (B1.3) and (B1.4): 0.5 to 5000, in particular 10-1500, g of a.s./ha, mainly against weed grasses by the post-emergence method, if appropriate in combination with safeners;

compounds of groups (B1.5): 10 to 5000, in particular 20 to 4000, g of a.s./ha, mainly against weed grasses by the post-emergence and pre-emergence method;

compounds of groups (B1.6): 0.5 to 2000, in particular 10 to 1500, g of a.s./ha, mainly against weed grasses by the post-emergence and pre-emergence method;

compounds of group (B2.1): 0.5 to 500, in particular 2.5-80, g of a.s./ha, predominantly against broad-leaved weeds by the post-emergence method;

compounds of group (B2.2): 20 to 5000, in particular 50-2000, g of a.s./ha, predominantly against broad-leaved weeds and Cyperaceae by the post-emergence method;

compounds of group (B2.3): 1-3000, in particular 5-2000, g of a.s./ha predominantly against broad-leaved weeds by the post-emergence method;

compounds of group (B2.4): 1 to 3000, in particular 2 to 1500, g of a.s./ha predominantly against broad-leaved weeds by the post-emergence method;

compounds of group (B2.5): 1 to 1000, in particular 2 to 200, g of a.s./ha against broad-leaved weeds by the pre- and post-emergence method;

compounds of group (B2.6): 0.5 to 5000, in particular 10 to 1500, g of a.s./ha against broad-leaved weeds by the pre- and/or post-emergence method;

compounds of group (B3.1): 0.5 to 2000, in particular 1 to 500, g of a.s./ha predominantly against broad-leaved weeds and weed grasses by the post-emergence, but also by the pre-emergence method;

compounds of group (B3.2): 10 to 5000, in particular 100 to 4000, very particularly preferably 300-3000, g of a.s./ha against broad-leaved weeds and weed grasses by the post-emergence and/or pre-emergence method;

compounds of group (B3.3): 10 to 5000, in particular 100 to 4000, very particularly preferably 200-3000, g of a.s./ha against broad-leaved weeds and weed grasses by the post-emergence and/or pre-emergence method;

compounds of group (B3.4): 0.5 to 5000, in particular 10 to 1500, g of a.s./ha against broad-leaved weeds and weed grasses by the post-emergence and/or pre-emergence method;

compounds of group (B4.1): 10 to 1000, in particular 20 to 600;

compounds of group (B4.2): 20 to 1000, in particular 20 to 800;

compounds of group (B4.3): 1 to 1000, in particular 10 to 200;

compounds of group (B4.4): 10 to 8000, in particular 10 to 6000.

Ranges of suitable ratios of compounds (A) and (B) result from the above-mentioned application rates for the individual substances. In the combinations according to the invention, it is generally possible to reduce the application rates.

Preferred mixing ratios (based on weight) for the combinations are listed below:

(A):(B1) in the range from 2000:1 to 1:500, preferably from 500:1 to 1:150, in particular from 75:1 to 1:80;

(A):(B2) in the range from 1600:1 to 1:500, preferably from 600:1 to 1:150, in particular from 40:1 to 1:60;

(A):(B3) in the range from 9000:1 to 1:600, preferably from 700:1 to 1:250, in particularfrom 100:1 to 1:150;

(A):(B4) in the range from 120:1 to 1:400, preferably from 40:1 to 1:250, in particular from 20:1 to 1:150.

Certain combinations of compounds (A) and (B) are particularly suitable for use in the following crops:

Suitable for use in cereals (wheat, barley, etc.) are combinations of compounds (A) with the compounds (B1.1.1) to (B1.3.3), (B1.4.5), (B1.6.1), (B1.6.18)/(B1.6.19), (B2.1.1)/(B2.1.2), (B2.1.4), (B2.1.7), (B2.2.1)-(B2.2.5), (B2.3.1)/(B2.3.2), (B2.4.1), (B2.5.2), (B2.6.2), (B2.6.3)/(B2.6.4), (B2.6.8), (B2.6.10), (B3.1.1)-(B3.1.5), (B3.1.7), (B3.4.1)-(B3.4.3), (B4.3.3).

Suitable for use in corn are combinations of compounds (A) with the compounds (B1.5.1), (B1.6.2), (B2.1.3), (B2.1.6), (B2.1.8)-(B2.1.13), (B2.2.6), (B2.4.2), (B2.6.5), (B2.6.7), (B3.1.8)-(B3.1.11), (B3.2.1)-(B3.2.4), (B3.3.1)-(B3.3.3), (B3.4.2)/(B3.4.4)/(B3.4.5), (B3.4.8)/(B3.4.9).

Suitable for use in rice are combinations of compounds (A) with the compounds (B1.3.8), (B1.4.4), (B1.5.2)-(B1.5.4), (B1.6.3)-(B1.6.17), (B2.1.5), (B2.1.6), (B2.6.11)-(B2.6.15), (B3.4.10 (B3.4.14).

Suitable for nonselective use in perennial crops are combinations of compounds (A) with the compounds (B2.2.8), (B3.4.6), (B4.2.1), (B4.2.2), (B4.3.5), (B4.4.1)-(B4.4.4).

Suitable for use in dicotyledonous crops such as oilseed rape, sugar beet and soybean are combinations of compounds (A) with the compounds (B1.3.4)-(B1.3.7), (B1.4.1), (B1.4.2), (B1.4.3), (B2.2.7), (B2.4.3), (B2.5.1), (B2.6.6), (B2.6.9), (B3.4.7), (B3.4.15)-(B3.4.19), (B4.3.1), (B4.3.2), (B4.3.4), (B4.3.6).

In individual cases, it may be expedient to combine one of the compounds (A) with a plurality of compounds (B) from the classes (B1), (B2), (B3) and/or (B4). Furthermore, the combinations according to the invention may be employed together with other active compounds, for example from the group of the safeners, fungicides, insecticides and plant growth regulators, or from the group of the additives and formulation auxiliaries which are customary in crop protection.

Preference is given to herbicide combinations according to the invention comprising such an amount of safeners (C) that they act as antidotes, to reduce the phytotoxic side effects of the herbicides used in economically important crops such as cereals (wheat, barley, rye, corn, rice, millet), sugar beet, sugar cane, oilseed rape, cotton and soybean. The herbicide combinations are preferably employed in cereals.

Suitable safeners are, for example, the compounds mentioned in WO00/16627 on pages 53 to 58 under groups a) to s) and in the literature cited therein.

The combinations according to the invention (=herbicidal compositions) have an outstanding herbicidal activity against a broad spectrum of economically important monocotyledonous and dicotyledonous harmful plants. The active ingredients also act efficiently on perennial weeds which produce shoots from rhizomes, rootstocks or other perennial organs and which are difficult to control.

Specifically, examples may be mentioned of some representatives of the monocotyledonous and dicotyledonous weed flora which can be controlled by the compounds according to the invention, without the enumeration being a restriction to certain species.

Examples of weed species on which the herbicidal compositions act efficiently are, from amongst the monocotyledonous weed species, Avena spp., Alopecurus spp., Brachiaria spp., Digitaria spp., Lolium spp., Echinochloa spp., Panicum spp., Phalaris spp., Poa spp., Setaria spp. and Cyperus species from the annual group, and, amongst the perennial species, Agropyron, Cynodon, Imperata and Sorghum and also perennial Cyperus species.

In the case of the dicotyledonous weed species, the spectrum of action extends to species such as, for example, Abutilon spp., Amaranthus spp., Chenopodium spp., Chrysanthemum spp., Galium spp., Ipomoea spp., Kochia spp., Lamium spp., Matricaria spp., Pharbitis spp., Polygonum spp., Sida spp., Sinapis spp., Solanum spp., Stellaria spp., Veronica spp. and Viola spp., Xanthium spp., amongst the annuals, and Convolvulus, Cirsium, Rumex and Artemisia in the case of the perennial weeds.

If the compounds according to the invention are applied to the soil surface before germination, then the weed seedlings are either prevented completely from emerging, or the weeds grow until they have reached the cotyledon stage but then their growth stops, and, eventually, after three to four weeks have elapsed, they die completely.

If the compositions are applied post-emergence to the green parts of the plants, growth likewise stops drastically a very short time after the treatment and the weed plants remain at the growth stage of the point of time of application, or they die completely after a certain time, so that in this manner competition by the weeds, which is harmful to the crop plants, is eliminated at a very early point in time and in a sustained manner.

The herbicidal compositions according to the invention are distinguished by a rapidly commencing and long-lasting herbicidal action. As a rule, the rainfastness of the active ingredients in the combinations according to the invention is advantageous. A particular advantage is that the dosages of the compounds (A) and (B), which are used in the combinations and are effective, can be adjusted to such a low quantity that their soil action is optimally low. This does not only allow them to be employed in sensitive crops in the first place, but groundwater contaminations are virtually avoided. The active-ingredient combination according to the invention allows the application rate of the active ingredients required to be reduced considerably.

When herbicides of the type (A)+(B) are used jointly, superadditive (=synergistic) effects are observed. This means that the effect in the combinations exceeds the expected total of the effects of the individual herbicides employed. The synergistic effects allow the application rate to be reduced, a broader spectrum of broad-leaved weeds and grass weeds to be controlled, the herbicidal action to take place more rapidly, the duration of action to be longer, the harmful plants to be controlled better while using only one, or few, applications, and the application period which is possible to be extended. In some cases, use of the compositions also reduces the amount of harmful constituents, such as nitrogen or oleic acid, and their entry into the ground.

The abovementioned properties and advantages are necessary for weed control practice to keep agricultural crops free from undesired competing plants and thus to guarantee and/or increase the yields from the qualitative and quantitative point of view. These novel combinations markedly exceed the technical state of the art with a view to the properties described.

While the combinations according to the invention have an outstanding herbicidal activity against monocotyledonous and dicotyledonous weeds, the crop plants are damaged only to a minor extent, if at all.

Moreover, some of the compositions according to the invention have outstanding growth-regulatory properties on the crop plants. They engage in the plants' metabolism in a regulatory manner and can thus be employed for provoking directed effects on plant constituents and to facilitate harvesting such as for example by triggering desiccation and stunted growth. Moreover, they are also suitable for the general control and inhibition of undesired vegetative growth without simultaneously destroying the plants. An inhibition of vegetative growth is very important in a large number of monocotyledonous and dicotyledonous crops since lodging can thus be reduced, or prevented completely.

Owing to their herbicidal and plant-growth-regulatory properties, the compositions can be employed for controlling harmful plants in known plant crops or tolerant or genetically modified crop plants still to be developed. The transgenic plants are generally distinguished by particular, advantageous properties, such as resistances to plant diseases or causative agents of plant diseases such as particular insects or microorganisms such as fungi, bacteria or viruses in addition to resistances to the compositions according to the invention. Other particular properties relate, for example, to the harvested material with regard to quantity, quality, storability, composition and specific constituents. Thus, for example, transgenic plants are known whose starch content is increased or whose starch quality is altered, or those where the harvested material has a different fatty acid composition.

Conventional methods of generating novel plants which have modified properties in comparison to plants occurring to date consist, for example, in traditional breeding methods and the generation of mutants. Alternatively, novel plants with altered properties can be generated with the aid of recombinant methods (see, for example, WO00/16627 pages 61 to 63 and the literature cited therein).

The invention therefore also relates to a method of controlling undesired vegetation, preferably in plant crops, which comprises applying one or more compositions of type (A) together with one or more herbicides of type (B) to the harmful plants, parts of these plants, or the area under cultivation. The invention also relates to the use of the herbicidal compositions of compounds (A)+(B) for controlling harmful plants, preferably in plant crops.

The active ingredient combinations according to the invention can exist not only as mixed formulations of the two components, if appropriate together with further active ingredients, additives and/or customary formulation auxiliaries, which are then applied in the customary manner as a dilution with water, but also as so-called tank mixes by jointly diluting the separately formulated, or partially separately formulated, components with water.

The compounds (A) and (B) or their combinations can be formulated in various ways, depending on the prevailing biological and/or chemical-physical parameters. The following are examples of general possibilities for formulations: wettable powders (WP), emulsifiable concentrates (EC), aqueous solutions (SL), emulsions (EW) such as oil-in-water and water-in-oil emulsions, sprayable solutions or emulsions, oil- or water-based dispersions, suspoemulsions, dusts (DP), seed-dressing materials, granules for soil application or for broadcasting, or water-dispersible granules (WG), ULV formulations, microcapsules or waxes.

The individual formulation types are known in principle and are described, for example, in: Winnacker-Küchler, “Chemische Technologie”, Volume 7, C. Hauser Verlag Munich, 4th Edition, 1986; van Valkenburg, “Pesticide Formulations”, Marcel Dekker N.Y., 1973; K. Martens, “Spray Drying Handbook”, 3rd Ed. 1979, G. Goodwin Ltd. London.

The formulation auxiliaries required, such as inert materials, surfactants, solvents and other additives are also known and are described, for example, in Watkins, “Handbook of Insecticide Dust Diluents and Carriers”, 2nd Ed., Darland Books, Caldwell N.J.; H.v. Olphen, “Introduction to Clay Colloid Chemistry”; 2nd Ed., J. Wiley & Sons, N.Y. Marsden, “Solvents Guide”, 2nd Ed., Interscience, N.Y. 1950; McCutcheon's, “Detergents and Emulsifiers Annual”, MC Publ. Corp., Ridegewood N.J.; Sisley and Wood, “Encyclopedia of Surface Active Agents”, Chem. Publ. Co. Inc., N.Y. 1964; Schonfeldt, “Grenzflachenaktive Athylenoxidaddukte” [Surface-active ethylene oxide adducts], Wiss. Verlagsgesellschaft, Stuttgart 1976, Winnacker-Kuchler, “Chemische Technologie”, Volume 7, C. Hauser Verlag Munich, 4th Edition 1986.

Based on these formulations, combinations with other pesticidally active substances, such as other herbicides, fungicides or insecticides, and with safeners, fertilizers and/or growth regulators, may also be prepared, for example in the form of a readymix or a tank mix.

Wettable powders (sprayable powders) are preparations which are uniformly dispersible in water and which, besides the active ingredient, also comprise ionic or nonionic surfactants (wetters, dispersants), for example polyoxethylated alkylphenols, polyethoxylated fatty alcohols or fatty amines, alkanesulfonates or alkylbenzenesulfonates, sodium lignosulfonate, sodium 2,2′-dinaphthylmethane-6,6′-disulfonate, sodium dibutylnaphthalenesulfonate or else sodium oleoylmethyltauride, in addition to a diluent or inert material.

Emulsifiable concentrates are prepared by dissolving the active ingredient in an organic solvent, for example butanol, cyclohexanone, dimethylformamide, xylene or else higher-boiling aromatics or hydrocarbons with addition of one or more ionic or nonionic surfactants (emulsifiers). Examples of emulsifiers which may be used are: calcium salts of alkylarylsulfonic acids, such as Ca dodecylbenzene sulfonate, or nonionic emulsifiers such as fatty acid polyglycol esters, alkylaryl polyglycol ethers, fatty alcohol polyglycol ethers, propylene oxide/ethylene oxide condensates, alkyl polyethers, sorbitan fatty acid esters, polyoxyethylene sorbitan fatty acid esters or polyoxethylene sorbitol esters.

Dusts are obtained by grinding the active ingredient with finely divided solid materials, for example talc, natural clays such as kaolin, bentonite and pyrophyllite, or diatomaceous earth.

Granules can be prepared either by spraying the active ingredient onto adsorptive, granulated inert material or by applying active ingredient concentrates to the surface of carriers such as sand, kaolinites or granulated inert material with the aid of binders, for example polyvinyl alcohol, sodium polyacrylate or else mineral oils. Suitable active ingredients may also be granulated in the manner conventionally used for the production of fertilizer granules, if desired in a mixture with fertilizers. In general, water-dispersible granules are prepared by processes such as spray drying, fluidized-bed granulation, disk granulation, mixing with high-speed mixers and extrusion without solid inert material.

In general, the agrochemical formulations comprise 0.1 to 99 percent by weight, in particular 2 to 95% by weight, of active ingredients of the types A and/or B, the following concentrations being customary, depending on the type of formulation: The active ingredient concentration in wettable powders is, for example, approximately 10 to 95% by weight, the remainder to 100% by weight being composed of customary formulation constituents. In the case of emulsifiable concentrates, the active ingredient concentration may amount to, for example, 5 to 80% by weight.

Formulations in the form of dusts comprise, in most cases, 5 to 20% by weight of active ingredient, sprayable solutions approximately 0.2 to 25% by weight of active ingredient.

In the case of granules such as dispersible granules, the active ingredient content depends partly on whether the active compound is present in liquid or solid form and on which granulation auxiliaries and fillers are being used. As a rule, the content amounts to between 10 and 90% by weight in the case of the water-dispersible granules.

In addition, the abovementioned active ingredient formulations may comprise, if appropriate, the conventional adhesives, wetters, dispersants, emulsifiers, preservatives, antifreeze agents, solvents, fillers, colorants, carriers, antifoams, evaporation inhibitors, pH regulators or viscosity regulators, thickeners, fertilizers and/or dyes.

For use, the formulations, which are present in commercially available form, are optionally diluted in the customary manner, for example using water in the case of wettable powders, emulsifiable concentrates, dispersions and water-dispersible granules. Preparations in the form of dusts, soil granules, granules for broadcasting and sprayable solutions are usually not diluted further with other inert substances prior to use.

The herbicidal compositions can be applied to the plants, parts of the plants, seeds of the plants or the area under cultivation (soil of the field), preferably to the green plants and parts of the plants and, if appropriate, additionally to the soil of the field. One possible use is the joint application of the active ingredients in the form of tank mixes, the concentrated formulations of the individual active ingredients, in optimal formulations, jointly being mixed with water in the tank and the resulting spray mixture being applied.

A joint herbicidal formulation of the combination according to the invention of active ingredients (A) and (B) has the advantage of being easier to apply since the quantities of the components are already presented in the correct ratio to each other. Moreover, the adjuvants in the formulation can be matched optimally to each other, while a tank mix of different formulations may lead to undesired combinations of auxiliaries.

A. General Formulation Examples

a) A dust is obtained by mixing 10 parts by weight of an active ingredient active ingredient mixture and 90 parts by weight of talc as inert material and comminuting the mixture in a hammer mill.

b) A wettable powder which is readily dispersible in water is obtained by mixing 25 parts by weight of an active ingredient/active ingredient mixture, 64 parts by weight of kaolin-containing quartz as inert material, 10 parts by weight of potassium lignosulfonate and 1 part by weight of sodium oleoylmethyltaurinate as wetter and dispersant, and grinding the mixture in a pinned-disk mill.

c) A dispersion concentrate which is readily dispersible in water is obtained by mixing 20 parts by weight of an active ingredient/active ingredient mixture with 6 parts by weight of alkylphenol polyglycol ether (®7 Triton X 207), 3 parts by weight of isotridecanol polyglycol ether (8 EO) and 71 parts by weight of paraffinic mineral oil (boiling range for example approx. 255 to 277° C.), and grinding the mixture in a ball mill to a fineness of below 5 microns.

d) An emulsifiable concentrate is obtained from 15 parts by weight of an active ingredient/active ingredient mixture, 75 parts by weight of cyclohexanone as solvent and 10 parts by weight of oxethylated nonylphenol as emulsifier.

e) Water-dispersible granules are obtained by mixing

75 parts by weight of an active ingredient/active ingredient mixture,

10 parts by weight of calcium lignosulfonate,

5 parts by weight of sodium lauryl sulfate,

3 parts by weight of polyvinyl alcohol and

7 parts by weight of kaolin,

grinding the mixture on a pinned-disk mill and granulating the powder in a fluidized bed by spraying on water as granulation liquid.

f) Water-dispersible granules are also obtained by homogenizing and precomminuting, in a colloid mill,

25 parts by weight of an active ingredient/active ingredient mixture,

5 parts by weight of sodium 2,2′-dinaphthylmethane-6,6′-disulfonate,

2 parts by weight of sodium oleoylmethyltaurinate,

1 part by weight of polyvinyl alcohol,

17 parts by weight of calcium carbonate and

50 parts by weight of water,

subsequently grinding the mixture in a bead mill and atomizing and drying the resulting suspension in a spray tower by means of a single-substance nozzle.

### BIOLOGICAL EXAMPLES

1. Pre-Emergence Effect on Weeds

Seeds or rhizome pieces of monocotyledonous and dicotyledonous weed plants are placed in sandy loam soil in pots and covered with soil. The compositions, formulated in the form of concentrated aqueous solutions, wettable powders or emulsion concentrates, are then applied to the surface of the soil cover as aqueous solution, suspension or emulsion at an application rate of 600 to 800 l of water/ha (converted), in various dosages. After the treatment, the pots are placed in a greenhouse and kept under good growth conditions for the weeds. After the test plants have emerged, the damage to the plants or the negative effects on the emergence is scored visually after a test period of 3 to 4 weeks by comparison with untreated controls. As shown by the test results, the compositions according to the invention have good herbicidal pre-emergence activity against a broad spectrum of weed grasses and broad-leaved weeds.

Scoring and Evaluation of the Synergistic Herbicidal Effects:

The herbicidal efficacy of the active compounds or active compound mixtures was scored visually using the treated plots in comparison to untreated control plots. The damage and development of all above-ground parts of the plants were recorded. Scoring was carried out using a percentage scale (100% effect=all plants killed; 50% effect=50% of the plants and the green parts of the plants killed; 0% effect=no noticeable effect=like control plot. The scores of in each case 4 plots were averaged.

When using the combinations according to the invention, herbicidal effects on a harmful plant species are frequently observed which exceed the formal sum of the activities of the herbicides contained in the combination when applied on their own. Alternatively, in some cases, it can be observed that a lower application rate is required for the herbicide combination in order to obtain, compared to the individual preparations, the same effect on a harmful plant species. Such activity increases or increases in effectiveness or reduced application rates are a strong indication of a synergistic effect.

If the observed activity values already exceed the formal sum of the values for the trials with the individual applications, they also exceed the expected value according to Colby which is calculated using the following formula and which is likewise considered to be an indication of synergism (cf. S. R. Colby; in Weeds 15 (1967) pp. 20 to 22):

E=A+B−(A×B/100)

The figures denote: A, B=activity of the active compounds A or B in % at an application rate a or b g of a.s./ha; E=expected value of efficiency in % of the active compound combination at an application rate of a+b g of a.s./ha (a.s.=active substance).

The observed test results show, at suitable low dosages, an effect of the combinations which exceeds the formal sum of the effects in the case of individual application or the expected values according to Colby.

2. Post-Emergence Effect on Weeds

Seeds or rhizome pieces of monocotyledonous and dicotyledonous weeds are placed in sandy loam soil in pots, covered with soil and grown in a greenhouse under good growth conditions (temperature, atmospheric humidity, water supply). Three weeks after sowing, the test plants are treated at the three-leaf stage with the compositions according to the invention. The compositions according to the invention, formulated as wettable powders or as emulsion concentrates, are sprayed, at various dosages, onto the green parts of the plant at an application rate of 600 to 800 l of water/ha (converted). After the test plants have been in the greenhouse for about 3 to 4 weeks under ideal growth conditions, the effect of the preparations is scored visually by comparison with untreated controls (cf. Section 1). The compositions according to the invention also have a good herbicidal post-emergence activity against a broad spectrum of economically important weed grasses and broad-leaved weeds.

Frequently, activities of the combinations according to the invention are observed which exceed the formal sum of the activities when the herbicides are applied individually. The observed test results show, at suitable low dosages, an effect of the combinations which exceeds the formal sum of the effects in the case of individual application or the expected values according to Colby.

3. Herbicidal Effect and Crop Plant Compatibility (Field Trials)

Crop plants were grown outdoors on plots under natural outdoor conditions, and seeds or rhizome pieces of typical harmful plants were laid out or the natural weed growth was utilized. Treatment with the compositions according to the invention was carried out after the harmful plants had emerged and the crop plants were, generally, at the 2- to 4-leaf stage; in some cases (as stated), application of individual active compounds or active compound combinations was carried out pre-emergence (cf. Section 1) or post-emergence (cf. Section 2) or as a sequential treatment partly pre-emergence and/or post-emergence. After the application, for example 2, 4, 6 and 8 weeks after the application, the effect of the preparations was scored visually by comparison with untreated controls (cf. scoring in Section 1). In the field trial as well, the compositions according to the invention have synergistic herbicidal activity against a broad spectrum of economically important weed grasses and broad-leaved weeds. The comparison showed that the combinations according to the invention in most cases have a higher, in some cases a considerably higher, herbicidal activity than the sum of the activities of the individual herbicides, thus indicating synergism. Moreover, the effects in essential phases of the scoring period were above the expected values according to Colby, also indicating synergism. In contrast, the crop plants were, as a consequence of the treatments with the herbicidal compositions, damaged only to a small degree, if at all.

3.1 Field Trial in Winter Wheat, Post-Emergence Method

The compounds (A1), (A4), (A36) and (A39) from Tables 1 to 3 are used alone or else in combination with compounds (B3.1.4) (=iodosulfuron-methyl sodium salt) at 2 g of active substance per hectare (g a.s./ha) or (B3.1.5) (=mesosulfuron) at 10 g of a.s./ha or with a combination of (B3.1.4)+(B3.1.5) at 9+2 g a.s./ha, with a view to the damage in winter wheat and the action against harmful plants. The herbicide combinations mentioned of the components (A)+(B) according to the invention mentioned have very good selectivity in winter wheat and exhibit, for example in the case of the harmful plant Apera spica-venti (wind grass), a synergistic herbicidal action which exceeds the formal sum of the actions of the individual applications (A) and (B).

1. A herbicide combination having a synergistically active content of components (A) and (B), where
component (A) is one or more herbicidally active aminotriazine compounds of the formula (I) or salts thereof, 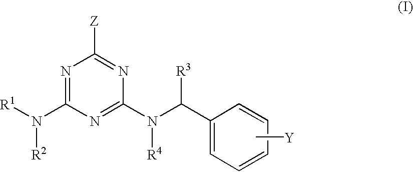
where
Z is hydrogen, hydroxyl, halogen or
(C₁-C₁₀)alkyl, (C₂-C₁₀)alkenyl, (C₂-C₁₀)alkynyl, where each of the three last-mentioned substituents is unsubstituted or substituted by one or more radicals selected from the group consisting of halogen, hydroxyl, amino, mercapto, cyano, nitro, thiocyanato, formyl, (C₁-C₄)alkoxy, mono(C₁-C₄)alkylamino, di(C₁-C₄)alkylamino, (C₁-C₄)haloalkoxy, (C₂-C₄)alkenyloxy, (C₂-C₄)haloalkenyloxy, (C₂-C₄)alkynyloxy, (C₂-C₄)haloalkynyloxy, (C₁-C₄)alkylthio, (C₁-C₄)alkylsulfinyl, (C₁-C₄)haloalkylsulfinyl, (C₁-C₄)alkylsulfonyl, (C₁-C₄)haloalkylsulfonyl, [(C₁-C₄)alkyl]carbonyl, [(C₁-C₄)haloalkyl]carbonyl, [(C₁-C₄)alkoxy]carbonyl, (C₃-C₉)cycloalkyl, (C₅-C₆)cycloalkenyl, phenyl and heterocyclyl, where each of the 4 last-mentioned radicals is unsubstituted or substituted, or
[(C₁-C₆)alkyl]carbonyl, [(C₁-C₆)alkoxy]carbonyl, (C₁-C₆)alkylsulfinyl or (C₁-C₄)alkylsulfonyl, where each of the 4 last-mentioned radicals is unsubstituted or substituted, or
(C₃-C₆)cycloalkyl, which is unsubstituted or substituted, (C₅-C₆)cycloalkenyl, which is unsubstituted or substituted,
R¹ and R² independently of one another are
H, formyl, (C₁-C₁₀)alkyl, (C₂-C₁₀)alkenyl, (C₂-C₁₀)alkynyl, (C₁-C₁₀)alkylsulfinyl, (C₁-C₁₀)alkylsulfonyl, (C₁-C₁₀)alkoxy, [(C₁-C₁₀)alkyl]carbonyl, [(C₁-C₁₀)alkyl]thiocarbonyl, phenylcarbonyl, naphthylcarbonyl, phenylthiocarbonyl, naphthylthiocarbonyl, [(C₁-C₁₀)alkoxy]carbonyl, [(C₁-C₁₀)alkoxy]thiocarbonyl, aminocarbonyl, mono[(C₁-C₁₀)alkyl]aminocarbonyl, di[(C₁-C₁₀)alkyl]aminocarbonyl, aminothiocarbonyl, mono[(C₁-C₁₀)alkyl]aminothiocarbonyl or di[(C₁-C₁₀)alkyl]aminothiocarbonyl, where each of the 20 last-mentioned radicals is unsubstituted or substituted,
or
(C₃-C₆)cycloalkyl, (C₅-C₆)cycloalkenyl, (C₃-C₆)cycloalkoxy, (C₅-C₆)cycloalkenyloxy, phenyl, phenoxy, phenylamino, phenylsulfonyl, heterocyclyl, heterocyclyloxy, heterocyclylamino, heterocyclylcarbonyl, heterocyclylsulfonyl, where each of the 13 last-mentioned radicals is unsubstituted or substituted, or
R¹ and R² together are (C₁-C₁₀)alkylidene which is unsubstituted or substituted by one or more radicals selected from the group consisting of halogen, cyano, (C₁-C₄)alkoxy, (C₁-C₄)haloalkoxy, (C₁-C₄)monoalkylamino, (C₁-C₄)dialkylamino and (C₁-C₄)alkylthio, or
NR¹R² together are a heterocyclyl radical which has 3 to 6 ring atoms, is attached at the nitrogen atom and, in addition to the nitrogen atom, optionally contains, as hetero ring atom, 1 to 3 further hetero ring atoms selected from the group consisting of N, O and S, the heterocycle being unsubstituted or substituted, and
R³ is halogen, CN, NO₂, SCN or a radical of the formula —X¹—A¹, where
X¹ is a direct bond or a divalent group of the formula —O—, —S(O)ₚ—, —S(O)ₚ—O—, —O—S(O)P—, —CO—, —O—CO—, —CO—O—, —S—CO—, —CO—S—, —S—CS—, —CS—S—, —O—CO—O—, —NR^{O}—, —O—NR^{O}—, —NR^{O}—O—, —NR^{O}—CO—, —CO—NR^{O}—, —O—CO—NR^{O}— or —NR^{O}—CO—O—, where in each case p is the integer 0, 1 or 2 and R^{O} is hydrogen, (C₁-C₆)alkyl, (C₂-C₆)alkenyl, (C₂-C₆)alkynyl, phenyl, phenyl-(C₁-C₆)alkyl, (C₃-C₆)cycloalkyl or [(C₁-C₆)alkyl]carbonyl, and
A¹ is hydrogen, (C₁-C₁₀)alkyl, (C₂-C₁₀)alkenyl, (C₂-C₁₀)alkynyl, (C₃-C₆)cycloalkyl, (C₅-C₆)cycloalkenyl, phenyl or heterocyclyl having 3 to 9 ring atoms and 1 to 4 hetero ring atoms selected from the group consisting of N, O and S, where each of the 7 last-mentioned radicals is unsubstituted or substituted, and
R⁴ is H or formyl, (C₁-C₁₀)alkyl, (C₂-C₁₀)alkenyl, (C₂-C₁₀)alkynyl, (C₁-C₁₀)alkylsulfinyl, (C₁-C₁₀)alkylsulfonyl, (C₁-C₁₀)alkoxy, [(C₁-C₁₀)alkyl]carbonyl, [(C₁-C₁₀)alkoxy]carbonyl, where each of the 8 last-mentioned radicals is unsubstituted or substituted, or (C₃-C₆)cycloalkyl, (C₅-C₆)cycloalkenyl, (C₃-C₆)cycloalkoxy, (C₅-C₆)cycloalkenyloxy, phenyl, phenoxy, phenylamino, phenylcarbonyl, phenylsulfonyl, heterocyclyl, heterocyclyloxy, heterocyclylamino, heterocyclylcarbonyl or heterocyclylsulfonyl, where each of the 14 last-mentioned radicals is unsubstituted or substituted,
or a group of the formula NR^{a}R^{b}, where R^{a} and R^{b} independently of one another are H, formyl, (C₁-C₆)alkyl, (C₂-C₆)alkenyl, (C₂-C₆)alkynyl, (C₁-C₆)alkylsulfinyl, (C₁-C₆)alkylsulfonyl, (C₁-C₆)alkoxy, (C₁-C₆)alkylcarbonyl or [(C₁-C₆)alkoxy]carbonyl, where each of the 8 last-mentioned groups is unsubstituted or substituted, or
R^{a} and R^{b} together are straight-chain (C₂-C₅)alkylene which is unsubstituted or substituted by one or more radicals selected from the group consisting of (C₁-C₄)alkyl, (C₁-C₄)alkoxy, (C₁-C₄)alkoxy-(C₁-C₄)alkyl and oxo, and
Y is halogen, nitro, cyano, thiocyanato or a radical of the formula —X²—A², where
X² is a direct bond or a divalent group of the formula —O—, —S(O)_{q}—, —S(O)_{q}—O—, —O—S(O)_{q}—, —S(O)_{q}—NR^{r}—, —NR^{r}—S(O)_{q}—, —CO—, —O—CO—, —CO—O—, —S—CO—, —CO—S—, —S—CS—, —CS—S—, —O—CO—O—, —NR^{r}—, —O—NR^{r}—, —NR^{r}—O—, —NR^{r}—CO—, —CO—NR^{r}—, —O—CO—NR^{r}— or —NR^{r}—CO—O—, where in each case q is the integer 0, 1 or 2 and R^{r} is hydrogen, amino, substituted amino, (C₁-C₆)alkyl, (C₂-C₆)alkenyl, (C₂-C₆)alkynyl, phenyl, phenyl-(C₁-C₆)alkyl, phenylcarbonyl, (C₃-C₆)cycloalkyl, (C₅-C₆)cycloalkenyl, [(C₁-C₆)alkyl]-carbonyl, (C₁-C₆)alkylsulfonyl or (C₁-C₆)alkylsulfinyl, phenylsulfonyl or phenylsulfinyl, where each of the 13 last-mentioned radicals is unsubstituted or substituted, and
A² is hydrogen, (C₁-C₁₀)alkyl, (C₂-C₁₀)alkenyl, (C₂-C₁₀)alkynyl, (C3-C₆)cycloalkyl, (C₅-C₆)cycloalkenyl, phenyl or heterocyclyl, where each of the 7 last-mentioned radicals is unsubstituted or substituted,
where
the compounds of the formula (I) are optically active and not present as racemic compound,
and
component (B) is one or more herbicides selected from the group of compounds consisting of
(B1) foliar- and/or soil-acting herbicides which are active against monocotyledonous harmful plants,
(B2) herbicides which are active against predominantly dicotyledonous harmful plants,
(B3) herbicides which are active against monocotyledonous and dicotyledonous harmful plants and
(B4) herbicides which are active against monocotyledonous and dicotyledonous harmful plants and which can be employed specifically in tolerant crops or on non-crop land.

2. The herbicide combination as claimed in claim 1, wherein in compounds of the formula (I) or salts thereof
Z is hydrogen, halogen or
(C₁-C₆)alkyl, (C₂-C₆)alkenyl, (C₂-C₆)alkynyl, where each of the three last-mentioned substituents is unsubstituted or substituted by one or more radicals selected from the group consisting of halogen, cyano, formyl, (C₁-C₄)alkoxy, mono(C₁-C₄)alkylamino, di(C₁-C₄)alkylamino, (C₁-C₄)haloalkoxy, (C₁-C₄)alkylsulfonyl, (C₁-C₄)haloalkylsulfonyl, [(C₁-C₄)alkyl]carbonyl, [(C₁-C₄)alkoxy]carbonyl, (C₃-C₆)cycloalkyl, (C₅-C₆)cycloalkenyl and phenyl, where each of the 3 last-mentioned radicals is unsubstituted or substituted by one or more radicals selected from the group consisting of halogen, cyano, (C₁-C₄)alkyl, (C₁-C₄)haloalkyl, (C₁-C₄)alkoxy, (C₁-C₄)haloalkoxy and (C₁-C₄)alkylthio, or
(C₃-C₆)cycloalkyl which is unsubstituted or substituted by one or more radicals selected from the group consisting of halogen, cyano, (C₁-C₄)alkyl, (C₁-C₄)haloalkyl, (C₁-C₄)alkoxy, (C₁-C₄)haloalkoxy and (C₁-C₄)alkylthio,
R¹ and R² independently of one another are
H, formyl, (C₁-C₆)alkyl, (C₂-C₆)alkenyl, (C₂-C₆)alkynyl, (C₁-C₆)alkylsulfinyl, (C₁-C₆)alkylsulfonyl, (C₁-C₆)alkoxy, [(C₁-C₆)alkyl]carbonyl, [(C₁-C₆)alkyl]thiocarbonyl, phenylcarbonyl, naphthylcarbonyl, phenylthiocarbonyl, naphthylthiocarbonyl, [(C₁-C₆)alkoxy]carbonyl, [(C₁-C₆)alkoxy]thiocarbonyl, aminocarbonyl, mono[(C₁-C₆)alkyl]aminocarbonyl, di[(C₁-C₆)alkyl]aminocarbonyl, aminothiocarbonyl, mono[(C₁-C₆)alkyl]aminothiocarbonyl or di[(C₁-C₆)alkyl]aminothiocarbonyl, where each of the 20 last-mentioned radicals is unsubstituted or substituted by one or more radicals selected from the group consisting of halogen, (C₁-C₄)alkoxy, (C₁-C₄)haloalkoxy, (C₁-C₄)hydroxyalkoxy and (C₁-C₄)alkoxy-(C₁-C₄)alkoxy and, in the case of cyclic radicals, also (C₁-C₄)alkyl, (C₁-C₄)haloalkyl, (C₁-C₄)alkoxy-(C₁-C₄)alkyl and (C₁-C₄)hydroxyalkyl,
or
(C₃-C₆)cycloalkyl, phenyl, where each of the 2 last-mentioned radicals is unsubstituted or substituted by one or more radicals selected from the group consisting of halogen, cyano, (C₁-C₄)alkyl, (C₁-C₄)haloalkyl, (C₁-C₄)alkoxy-(C₁-C₄)alkyl, (C₁-C₄)alkoxy, (C₁-C₄)haloalkoxy and (C₁-C₄)alkoxy-(C₁-C₄)alkoxy,
or one of the radicals R¹ and R² is as defined above and the other of the radicals R¹ and R² is a group of the formula NR′R″, where R′ and R″ independently of one another are H or (C₁-C₄)alkyl, or
R¹ and R² together are (C₁-C₆)alkylidene which is unsubstituted or substituted by one or more radicals selected from the group consisting of halogen, cyano, (C₁-C₄)alkoxy, (C₁-C₄)haloalkoxy, (C₁-C₄)monoalkylamino, (C₁-C₄)dialkylamino and (C₁-C₄)alkylthio, or
NR¹R² together are a heterocyclyl radical having 3 to 6 ring atoms which is attached at the nitrogen atom and contains the nitrogen atom as hetero ring atom,
R³ is halogen, CN, NO₂, SCN or a radical of the formula —X¹—A¹, where
X¹ is a direct bond or a divalent group of the formula —O—, —S(O)ₚ—, —S(O)ₚ—O—, —O—S(O)ₚ—, —CO—, —O—CO—, —CO—O—, —S—CO—, —CO—S—, —S—CS—, —CS—S—, —O—CO—O—, —NR^{O}—, —O—NR^{O}—, —NR^{O}—O—, —NR^{O}—CO—, —CO—NR^{O}—, —O—CO—NR^{O}— or —NR^{O}—CO—O—, preferably —O—, —S(O)ₚ—, —CO—, —O—CO—, —CO—O—, —S—CO—, —CO—S—, —NR^{O}—, —O—NR^{O}—, —NR^{O}—, —NR^{O}—CO—, —CO—NR^{O}—, —O—CO—NR^{O}— or —NR^{O}—CO—O—, where in each case p is the integer 0, 1 or 2 and R^{O} is hydrogen, (C₁-C₄)alkyl, (C₂-C₄)alkenyl, (C₂-C₄)alkynyl, phenyl, phenyl-(C₁-C₂)alkyl, (C₃-C₆)cycloalkyl or [(C₁-C₄)alkyl]carbonyl, and
A¹ is hydrogen, (C₁-C₆)alkyl, (C₂-C₆)alkenyl, (C₂-C₆)alkynyl, (C₃-C₆)cycloalkyl, phenyl or heterocyclyl having 3 to 9 ring atoms and 1 to 3 hetero ring atoms selected from the group consisting of N, O and S, where each of the 6 last-mentioned radicals is unsubstituted or substituted by one or more radicals selected from the group consisting of halogen, cyano, (C₁-C₄)alkyl, (C₃-C₆)cycloalkyl, (C₁-C₄)alkoxy, (C₁-C₄)haloalkoxy, (C₁-C₄)alkylthio and, in the case of cyclic radicals, also (C₁-C₄)haloalkyl and (C₁-C₄)alkoxy-(C₁-C₄)alkyl and, including substituents, has up to 16 carbon atoms,
R⁴ is H or formyl, (C₁-C₆)alkyl, (C₂-C₆)alkenyl, (C₂-C₆)alkynyl, (C₁-C₆)alkylsulfinyl, (C₁-C₆)alkylsulfonyl, (C₁-C₆)alkoxy, [(C₁-C₆)alkyl]carbonyl, [(C₁-C₆)alkoxy]carbonyl, where each of the 8 last-mentioned radicals is unsubstituted or substituted by one or more radicals selected from the group consisting of halogen, (C₁-C₄)alkoxy, (C₁-C₄)haloalkoxy and (C₁-C₄)hydroxyalkoxy, or
a group of the formula NR^{a}R^{b}, where R^{a} and R^{b} independently of one another are H or (C₁-C₄)alkyl,
Y is halogen, nitro, cyano, thiocyanato or a radical of the formula —X²—A², where
X² is a direct bond or a divalent group of the formula —O—, —S(O)_{q}—, —S(O)_{q}—O—, —O—S(O)_{q}—, —S(O)_{q}—NR^{r}—, —NR^{r}—S(O)_{q}—, —CO—, —O—CO—, —CO—O—, —S—CO—, —CO—S—, —S—CS—, —CS—S—, —CO—O—, —NR^{r}—, —O—NR^{r}—, —NR^{r}—O—, —NR^{r}—CO—, —CO—NR^{r}—, —O—CO—NR^{r}— or —NR—CO—O—, where in each case q is the integer 0, 1 or 2 and R^{r} in each case independently of one another are hydrogen, amino, mono- or di(C₁-C₄)alkylamino, mono- or di(C₁-C₄)arylamino, N—(C₁-C₄)alkyl-N-arylamino, (C₁-C₄)alkyl, (C₂-C₄)alkenyl, (C₂-C₄)alkynyl, phenyl, phenyl-(C₁-C₄)alkyl, phenylcarbonyl, (C₃-C₆)cycloalkyl, (C₅-C₆)cycloalkenyl, [(C₁-C₄)alkyl]carbonyl, (C₁-C₄)alkylsulfonyl, (C₁-C₄)alkylsulfinyl, phenylsulfonyl or phenylsulfinyl, where each of the 18 last-mentioned radicals is unsubstituted or substituted by one or more radicals selected from the group consisting of halogen, cyano, (C₁-C₄)alkyl, (C₁-C₄)alkoxy, (C₁-C₄)haloalkoxy and, in the case of cyclic radicals, also (C₁-C₄)haloalkyl and (C₁-C₄)alkoxy-(C₁-C₄)alkyl, and
A² is hydrogen, (C₁-C₆)alkyl, (C₂-C₆)alkenyl, (C₂-C₆)alkynyl, (C₃-C₆)cycloalkyl, (C₅-C₆)cycloalkenyl, phenyl or heterocyclyl having 3 to 6 ring atoms and 1 to 3 hetero ring atoms selected from the group consisting of N, O and S, where each of the 7 last-mentioned radicals is unsubstituted or substituted by one or more radicals selected from the group consisting of halogen, cyano, hydroxyl, amino or else mercapto or aminocarbonyl, mono- and di(C₁-C₄)alkylamino, mono- and di-phenylamino, N—(C₁-C₄)alkyl-N-phenylamino, mono- and di-[(C₁-C₄)alkanoyl]amino, mono- and di[(C₁-C₄)alkylsulfonyl]amino, N—(C₁-C₄)alkyl-N-[(C₁-C₄)alkanoyl]amino, (C₁-C₄)alkyl-N-[(C₁-C₄)alkylsulfonyl]amino, N-phenyl-N-[(C₁-C₄)alkanoyl]amino, N-phenyl-N-[(C₁-C₄)alkylsulfonyl]amino, (C₁-C₄)alkoxy, (C₁-C₄)alkylthio, (C₁-C₄)alkylsulfonyl, (C₁-C₄)alkylsulfinyl, [(C₁-C₄)alkyl]carbonyl, [(C₁-C₄)alkoxy]carbonyl, [(C₁-C₄)alkyl]carbonyloxy, (C₃-C₆)cycloalkyl, (C₃-C₆)cycloalkoxy, (C₃-C₆)cycloalkylcarbonyl, (C₃-C₆)cycloalkylcarbonyloxy, phenyl, phenoxy, phenylthio, phenylcarbonyl, phenylcarbonyloxy, heterocyclyl, heterocyclyloxy, heterocyclylthio, heterocyclylcarbonyl, heterocyclylcarbonyloxy and, in the case of cyclic radicals, also (C₁-C₆)alkyl, where each of the 35 last-mentioned radicals is unsubstituted or substituted by one or more radicals selected from the group consisting of halogen, cyano, hydroxyl, amino, mono- and di(C₁-C₄)alkylamino, mono- and diphenylamino, N-(C₁-C₄)alkyl-N-phenylamino, (C₁-C₄)alkoxy, (C₁-C₄)alkylthio, (C₃-C₆)cycloalkyl, (C₃-C₆)cycloalkoxy, phenyl, phenoxy and phenylthio and, in the case of cyclic radicals, also (C₁-C₄)alkyl, (C₁-C₄)haloalkyl and (C₁-C₄)alkoxy-(C₁-C₄)alkyl and A², including substituents, has up to 16 carbon atoms.

3. The herbicide combination as claimed in claim 1, wherein in compounds of the formula (I) or salts thereof
Z is (C₁-C₆)alkyl which is unsubstituted or substituted by one or more radicals selected from the group consisting of halogen, (C₃-C₆)cycloalkyl and phenyl, where each of the 2 last-mentioned radicals is unsubstituted or substituted by one or more radicals selected from the group consisting of halogen, (C₁-C₄)alkyl, (C₁-C₄)haloalkyl, (C₁-C₄)alkoxy, (C₁-C₄)haloalkoxy and (C₁-C₄)alkylthio, or
(C₃-C₆)cycloalkyl which is unsubstituted or substituted by one or more radicals selected from the group consisting of halogen, (C₁-C₄)alkyl, (C₁-C₄)haloalkyl, (C₁-C₄)alkoxy, (C₁-C₄)haloalkoxy and (C₁-C₄)alkylthio,
R¹ is hydrogen or (C₁-C₄)alkyl and
R² is hydrogen, formyl, aminocarbonyl, aminothiocarbonyl, (C₁-C₄)alkyl, (C₁-C₄)alkylsulfonyl, [(C₁-C₄)alkyl]carbonyl, [(C₁-C₄)alkoxy]carbonyl, where each of the 4 last-mentioned radicals is unsubstituted or substituted by one or more radicals selected from the group consisting of halogen and (C₁-C₄)alkoxy, or
(C₃-C₆)cycloalkyl which is unsubstituted or substituted by one or more radicals selected from the group consisting of halogen, (C₁-C₄)alkyl and (C₁-C₄)haloalkyl, or
R¹ and R² together are (C₁-C₆)alkylidene which is unsubstituted or substituted by one or more radicals selected from the group consisting of halogen and cyano,
R³ is halogen, CN, NO₂, SCN or a radical of the formula —X¹—A¹, where
X¹ is a direct bond or a divalent group of the formula —O—, —S(O)ₚ—, —S(O)ₚ—O—, —O—S(O)ₚ—, —CO—, —O—CO—, —CO—O—, —S—CO—, —CO—S—, —S—CS—, —CS—S—, —O—CO—O—, —NR^{O}—, —O—NR^{O}—, —NR^{O}—O—, —NR^{O}—CO—, —CO—NR^{O}—, —O—CO—NR^{O}— or —NR^{O}—CO—O— where in each case p is the integer 0, 1 or 2 and R^{O} is hydrogen, (C₁-C₄)alkyl, (C₂-C₄)alkenyl, (C₂-C₄)alkynyl, phenyl, phenyl-(C₁-C₂)alkyl, (C₃-C₆)cycloalkyl or [(C₁-C₄)alkyl]carbonyl, and
A¹ is hydrogen, (C₁-C₆)alkyl, (C₂-C₆)alkenyl, (C₂-C₆)alkynyl, (C₃-C₆)cycloalkyl, phenyl or heterocyclyl having 3 to 9 ring atoms and 1 to 3 hetero ring atoms selected from the group consisting of N, O and S, where each of the 6 last-mentioned radicals is unsubstituted or substituted by one or more radicals selected from the group consisting of halogen, cyano, (C₁-C₄)alkyl, (C₃-C₆)cycloalkyl, (C₁-C₄)alkoxy, (C₁-C₄)haloalkoxy, (C₁-C₄)alkylthio and, in the case of cyclic radicals, also (C₁-C₄)haloalkyl and (C₁-C₄)alkoxy-(C₁-C₄)alkyl and, including substituents, has up to 16 carbon atoms,
Y is halogen, nitro, cyano, thiocyanato or a radical of the formula —X²—A², where
X² is a direct bond or a divalent group of the formula —O—, —S(O)_{q}—, —S(O)_{q}—O—, —O—S(O)_{q}—, —S(O)_{q}—NR^{r}—, —NR^{r}—S(O)_{q}—, —CO—, —O—CO—, —CO—O—, —S—CO—, —CO—S—, —S—CS—, —CS—S—, —O—CO—O—, —NR^{r}—, —O—NR^{r}—, —NR^{r}—, —NR^{r}—CO—, —CO—NR^{r}—, —O—CO—NR^{r}— or —NR^{r}—CO—O—, where in each case q is the integer 0, 1 or 2 and R^{r} in each case independently of one another are hydrogen, amino, mono- or di(C₁-C₄)alkylamino, mono- or di(C₁-C₄)aryl-amino, N—(C₁-C₄)alkyl-N-arylamino, (C₁-C₄)alkyl, (C₂-C₄)alkenyl, (C₂-C₄)alkynyl, phenyl, phenyl-(C₁-C₄)alkyl, phenylcarbonyl, (C₃-C₆)— cycloalkyl, (C₅-C₆)cycloalkenyl, [(C₁-C₄)alkyl]carbonyl, (C₁-C₄)alkyl-sulfonyl, (C₁-C₄)alkylsulfinyl, phenylsulfonyl or phenylsulfinyl, where each of the 18 last-mentioned radicals is unsubstituted or substituted by one or more radicals selected from the group consisting of halogen, cyano, (C₁-C₄)alkyl, (C₁-C₄)alkoxy, (C₁-C₄)haloalkoxy and, in the case of cyclic radicals, also (C₁-C₄)haloalkyl and (C₁-C₄)alkoxy-(C₁-C₄)alkyl, and
A² is hydrogen, (C₁-C₆)alkyl, (C₂-C₆)alkenyl, (C₂-C₆)alkynyl, (C₃-C₆)cyclo-alkyl, (C₅-C₆)cycloalkenyl, phenyl or heterocyclyl having 3 to 6 ring atoms and 1 to 3 hetero ring atoms selected from the group consisting of N, O and S, where each of the 7 last-mentioned radicals is unsubstituted or substituted by one or more radicals selected from the group consisting of halogen, cyano, hydroxyl, amino or else mercapto or aminocarbonyl, mono- and di(C₁-C₄)alkylamino, mono- and di-phenylamino, N—(C₁-C₄)alkyl-N-phenylamino, mono- and di-[(C₁-C₄)alkanoyl]amino, mono- and di[(C₁-C₄)alkylsulfonyl]amino, N—(C₁-C₄)alkyl-N-[(C₁-C₄)alkanoyl]amino, (C₁-C₄)alkyl-N-[(C₁-C₄)alkylsulfonyl]amino, N-phenyl-N-[(C₁-C₄)alkanoyl]amino, N-phenyl-N-[(C₁-C₄)alkylsulfonyl]amino, (C₁-C₄)alkoxy, (C₁-C₄)al kylthio, (C₁-C₄)alkylsulfonyl, (C₁-C₄)alkylsulfinyl, [(C₁-C₄)alkyl]carbonyl, [(C₁-C₄)alkoxy]carbonyl, [(C₁-C₄)alkyl]carbonyloxy, (C₃-C₆)cycloalkyl, (C₃-C₆)cycloalkoxy, (C₃-C₆)cycloalkylcarbonyl, (C₃-C₆)cycloalkyl-carbonyloxy, phenyl, phenoxy, phenylthio, phenylcarbonyl, phenylcarbonyloxy, heterocyclyl, heterocyclyloxy, heterocyclylthio, heterocyclylcarbonyl, heterocyclylcarbonyloxy and, in the case of cyclic radicals, also (C₁-C₆)alkyl,
where each of the 35 last-mentioned radicals is unsubstituted or substituted by one or more radicals selected from the group consisting of halogen, cyano, hydroxyl, amino, mono- and di(C₁-C₄)alkylamino, mono- and diphenylamino, N—(C₁-C₄)alkyl-N-phenylamino, (C₁-C₄)alkoxy, (C₁-C₄)alkylthio, (C₃-C₆)cycloalkyl, (C₃-C₆)cycloalkoxy, phenyl, phenoxy and phenylthio and, in the case of cyclic radicals, also (C₁-C₄)alkyl, (C₁-C₄)haloalkyl and (C₁-C₄)alkoxy(C₁-C₄)alkyl and A², including substituents, has up to 16 carbon atoms.

4. The herbicide combination as claimed in claim 1, which comprises, as component (A), compounds of the formula (Ia) and salts thereof, 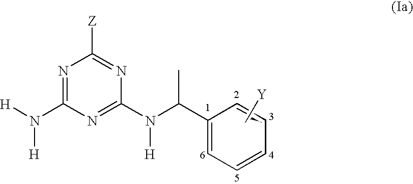
in which
Z is (C₁-C₄)alkyl or (C₁-C₄)haloalkyl,
Y is halogen, methyl, ethyl, methoxy, ethoxy or CF₃ and
where the compounds of the formula (I) are optically active and are not present as racemic compound.

5. The herbicide combination as claimed in claim 1, which comprises, as component (B), one or more compounds selected from the group consisting of groups (B1) to (B4), where are
(B1) foliar- and/or soil-acting herbicides which are active against monocotyledonous harmful plants, selected from
(B1.1) ureas which are predominantly soil-acting, selected from
(B1.1.1) isoproturon and
(B1.1.2) chlorotoluron,
(B1.2) compounds of various structures, which are predominantly soil-acting, selected from
(B1.2.1) flufenacet,
(B1.2.2) pendimethalin,
(B1.2.3) prosulfocarb,
(B1.3) 2-(4-heteroaryl- or 4-aryloxyphenoxy)propionic acids which are predominantly foliar-acting, selected from
(B1.3.1) clodinafop-propargyl,
(B1.3.2) diclofop-methyl,
(B1.3.3) fenoxaprop-P-ethyl,
(B1.3.4) quizalofop-P and its esters,
(B1.3.5) fluazifop-P and its esters,
(B1.3.6) haloxyfop and haloxyfop-P,
(B1.3.7) propaquizafop,
(B1.3.8) cyhalofop and its esters,
(B1.4) cyclohexanedione oximes which are predominantly foliar-acting, selected from
(B1.4.1) sethoxydim,
(B1.4.2) cycloxydim,
(B1.4.3) clethodim,
(B1.4.4) profoxydim,
(B1.4.5) tralkoxydim,
(B1.5) chloroacetamides which are predominantly soil-acting, selected from
(B1.5.1) dimethenamid,
(B1.5.2) penthoxamid,
(B1.5.3) butachlor,
(B1.5.4) pretilachlor,
(B1.6) compounds having various structures and foliar and/or soil action, selected from
(B1.6.1) imazamethabenz-methyl,
(B1.6.2) simazin,
(B1.6.3) molinate,
(B1.6.4) thiobencarb
(B1.6.5) oxaziclomefone,
(B1.6.6) anilofos,
(B1.6.7) cafenstrole,
(B1.6.8) mefenacet,
(B1.6.9) fentrazamid,
(B1.6.10) thiazopyr,
(B1.6.11) oxadiazon,
(B1.6.12) esprocarb,
(B1.6.13) pyributicarb,
(B1.6.14) azimsulfuron,
(B1.6.15) thenylchlor,
(B1.6.16) pentoxazone,
(B1.6.17) pyriminobac and its salts and esters,
(B1.6.18) flucarbazone and its salts,
(B1.6.19) procarbazone and its salts,
(B2) herbicides which are predominantly active against dicotyledonous plants, selected from
(B2.1) sulfonylureas, such as
(B2.1.1) tribenuron-methyl,
(B2.1.2) thifensulfuron and its esters,
(B2.1.3) prosulfuron,
(B2.1.4) amidosulfuron,
(B2.1.5) chlorimuron and its esters,
(B2.1.6) halosulfuron and its esters,
(B2.1.7) tritosulfuron,
(B2.1.8) bensulfuron-methyl,
(B2.1.9) ethoxysulfuron,
(B2.1.10) cinosulfuron,
(B2.1.11) pyrazosulfuron and its esters,
(B2.1.12) imazosulfuron,
(B2.1.13) cyclosulfamuron,
(B2.2) growth regulators (of the auxin type), selected from
(B2.2.1) MCPA
(B2.2.2) 2,4-D and its salts and esters,
(B2.2.3) dichlorprop-P, and its salts and esters,
(B2.2.4) mecoprop-P and its salts and esters,
(B2.2.5) fluoroxypyr and its salts and esters,
(B2.2.6) dicamba and its salts and esters,
(B2.2.7) clopyralid and its salts and esters,
(B2.2.8) picloram and its salts and esters,
(B2.3) hydroxybenzonitriles, selected from
(B.2.3.1) bromoxynil and its salts and esters,
(B.2.3.2) ioxynil and its salts and esters,
(B2.4) diphenyl ethers, selected from
(B2.4.1) fluoroglycofen-ethyl
(B2.4.2) aclonifen
(B2.4.3) acifluorfen and its salts,
(B2.5) [1,2,4]triazolopyrimidinesulfonamides, selected from
(B2.5.1) cloransulam and preferably the methyl ester,
(B2.5.2) florasulam,
(B2.6) compounds of various structures, selected from
(B2.6.1) bentazone,
(B2.6.2) bifenox,
(B2.6.3) carfentrazone-ethyl,
(B2.6.4) pyraflufen,
(B2.6.5) pyridate,
(B2.6.6) linuron,
(B2.6.7) diflufenzopyr and its salts,
(B2.6.8) cinidon-ethyl,
(B2.6.9) metribuzin,
(B2.6.10) picolinafen,
(B2.6.11) clomazone,
(B2.6.12) bromobutide,
(B2.6.13) benfuresate,
(B2.6.14) dithiopyr,
(B2.6.15) triclopyr and its salts and esters,
(B3) herbicides which are active against monocotyledonous and dicotyledonous harmful plants, selected from
(B3.1) sulfonylureas, selected from
(B3.1.1) metsulfuron-methyl,
(B3.1.2) triasulfuron,
(B3.1.3) chlorsulfuron,
(B3.1.4) iodosulfuron-methyl and its salts,
(B3.1.5) mesosulfuron,
(B3.1.6) sulfosulfuron,
(B3.1.7) flupyrsulfuron-methyl and its salts,
(B3.1.8) nicosulfuron,
(B3.1.9) rimsulfuron,
(B3.1.10) primisulfuron-methyl,
(B3.1.11) foramsulfuron,
(B3.2) triazine derivatives, selected from
(B3.2.1) cyanazine,
(B3.2.2) atrazin,
(B3.2.3) terbuthylazine,
(B3.2.4) terbutryn,
(B3.3) chloroacetamides, selected from
(B3.3.1) acetochlor,
(B3.3.2) S-metolachlor,
(B3.3.3) alachlor,
(B3.4) compounds of various structures, selected from
(B3.4.1) diflufenican,
(B3.4.2) flumetsulam,
(B3.4.3) flurtamone,
(B3.4.4) isoxaflutole,
(B3.4.5) metosulam,
(B3.4.6) paraquat (salts),
(B3.4.7) benoxacor,
(B3.4.8) sulcotrione,
(B3.4.9) mesotrione,
(B3.4.10) quinclorac,
(B3.4.11) propanil,
(B3.4.12) bispyribac (salts),
(B3.4.13) pyribenzoxim,
(B3.4.14) oxadiargyl,
(B3.4.15) norflurazon,
(B3.4.16) fluometuron,
(B3.4.17) methylarsonic acid (salts)
(B3.4.18) prometryn,
(B3.4.19) trifluralin,
(B4) herbicides which are active against monocotyledonous and dicotyledonous harmful plants and which can be employed specifically in tolerant crops and on non-crop land, selected from
(B4.1) compounds of the glufosinate or phosphinothricin (=L-glufosinate) type and their salts and derivatives, selected from
(B4.1.1) glufosinate (salts),
(B4.1.2) bilanafos (salts),
(B4.2) compounds of the type of the phosphonomethylglycine and its salts, selected from
(B4.2.1) glyphosate (salts),
(B4.2.2) sulfosate,
(B4.3) imidazolinones, selected from
(B4.3) imazapyr (salts),
(B4.3.2) imazethapyr (salts),
(B4.3.3) imazamethabenz (salts and esters),
(B4.3.4) imazamox (salts and esters),
(B4.3.5) imazaquin (salts and esters),
(B4.3.6) imazapic (salts and esters),
(B4.4) compounds of various structural types, selected from
(B4.4.1) WC9717 or CGA276854,
(B4.4.2) azafenidin,
(B4.4.3) diuron and
(B4.4.4) oxyfluorfen. and optionally their salts which can be used in agriculture.

6. The herbicide combination as claimed in claim 1, which comprises one or more further components selected from the group consisting of crop protection agents of a different type, additives customary in crop protection and formulation auxiliaries.

7. A method for controlling harmful plants, which comprises applying the herbicides of the herbicide combination as defined in claim 1 together or separately, pre-emergence, post-emergence or pre- and post-emergence, to the plants, parts of plants, plant seeds or the area under cultivation.

8. The method as claimed in claim 7 for the selective control of harmful plants in crops of plants.

9. The method as claimed in claim 8 for the control of harmful plants in cereals, corn or rice.
